(19) United States
(12) Patent Application Publication
(10) Pub. No.: US 2007/0195289 A1
(43) Pub. Date: Aug. 23, 2007

(54) Image projection apparatus

(75) Inventor: Soh Ohzawa, Toyonaka-shi (JP)

Correspondence Address: SIDLEY AUSTIN LLP, 717 NORTH HARWOOD, SUITE 3400, DALLAS, TX, 75201, US

(73) Assignee: KONICA MINOLTA OPTO, INC.

(21) Appl. No.: 11/708,274

(22) Filed: Feb. 20, 2007

(30) Foreign Application Priority Data
Feb. 22, 2006 (JP) 2006-045269

(51) Int. Cl. G03B 21/28

(52) U.S. Cl. 353/99

(57) ABSTRACT

A projector has a projection optical system unit, which has a positively powered optical system and a curved-mirror optical system. In the projector, a first curved mirror and a second curved mirror of the curved-mirror optical system are so arranged that the optical path that the base ray travels to reach the first curved mirror crosses the optical path that the base ray travels to leave the second curved mirror. Moreover, the second curved mirror has a negative optical power.

This application is based on Japanese Patent Application No. 2006-045269 filed on Feb. 22, 2006, the contents of which are hereby incorporated by reference.

### BACKGROUND OF THE INVENTION

1. Field of the Invention

The present invention relates to an image projection apparatus for projecting image light emitted from a light modulation element such as a DMD (Digital Micromirror Device, manufactured by Texas Instruments Incorporated) onto a screen surface.

2. Description of Related Art

Today, various projection apparatuses (such as projection television monitors) are being developed. For example, Patent Publication 1 listed below discloses an image projection apparatus wherein image light is repeatedly reflected while it is passed through a mirror optical system composed of a plurality of mirrors (a first mirror and a second mirror) so as to be projected onto a screen. So constructed, this image projection apparatus is slim.

Patent Publication 1: JP-A-H4-070806

What deserves particular mention about the image projection apparatus disclosed in Patent Publication 1 is that the optical path from the first to the second mirror crosses the optical path from the second mirror to the screen (i.e. these two optical paths cross each other). This prevents the overall optical path from running in one direction, and thus prevents the image projection apparatus from becoming large (thick) as a result of its optical path running in one direction.

The image projection apparatus disclosed in Patent Publication 1, however, has the following disadvantages. Since the first and second mirrors are both flat mirrors with hardly any optical power, it is difficult, with their optical power, to sufficiently enlarge the image light traveling toward the screen (i.e. it is difficult to sufficiently widen the angle of view of the image light). If a larger screen is attempted with this image projection apparatus, it is necessary to extend, for example, the optical path from the second mirror to the screen. Inconveniently, however, such extension of the optical path leads to an increased depth (thickness) of the image projection apparatus.

Another way to achieve enlargement projection is to feed the image light to the mirror optical system by use of a lens optical system having an optical power. Inconveniently, however, this requires large-diameter lenses in the lens optical system. Such large-diameter lenses may not be able to be accommodated inside the housing of the image projection apparatus.

### SUMMARY OF THE INVENTION

An object of the present invention is to provide an image projection apparatus that achieves enlargement projection despite being slim.

According to one aspect of the invention, in an image projection apparatus provided with a projection optical system unit that guides image light emitted from a light modulation element so as to project the image light onto a projection surface, the projection optical system unit includes: a positively powered optical system that has an optical aperture and that has a positive optical power; and a curved-mirror optical system that has at least a first curved mirror and a second curved mirror that reflects the light reflected from the first curved mirror.

Moreover, the first and second curved mirrors are so located that, let the ray of the image light that travels from the center of the display surface of the light modulation element through the center of the optical aperture toward the center of the projection surface be called the base ray, the optical path that the base ray travels to reach the first curved mirror crosses the optical path that the base ray travels to leave the second curved mirror. In addition, the second curved mirror has a convex reflective surface.

These and other objects and features of the present invention will be apparent from the following detailed description of preferred embodiments thereof taken in conjunction with the accompanying drawings.

### BRIEF DESCRIPTION OF THE DRAWINGS

FIG. 1 is a schematic optical cross-sectional view of a projector (Example 1);

FIG. 2 is a schematic optical cross-sectional view showing, mainly, the projection optical system unit included in the projector shown in FIG. 1;

FIG. 3 is a schematic perspective view of the projector of Example 1;

FIG. 4 is a spot diagram obtained with the projector of Example 1;

FIG. 5 is a distortion diagram obtained with the projector of Example 1;

FIG. 6 is a diagram illustrating θ1 to θ3 in the projector of Example 1;

FIG. 7 is a schematic optical cross-sectional view of another projector (Example 2);

FIG. 8 is a schematic optical cross-sectional view showing, mainly, the projection optical system unit included in the projector shown in FIG. 7;

FIG. 9 is a schematic perspective view of the projector of Example 2;

FIG. 10 is a spot diagram obtained with the projector of Example 2;

FIG. 11 is a distortion diagram obtained with the projector of Example 2;

FIG. 12 is a diagram illustrating θ1 to θ3 in the projector of Example 2;

FIG. 13 is a perspective view of a global coordinate system; and

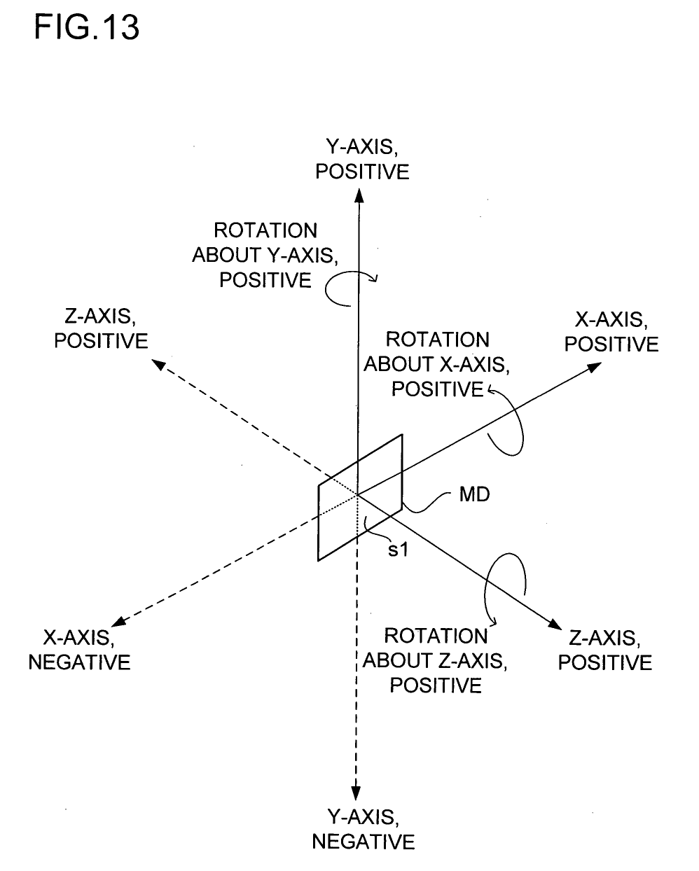

FIG. 14 is a schematic perspective view of a projector provided with an optical path changing element.

### DETAILED DESCRIPTION OF PREFERRED EMBODIMENTS

### 1. Embodiment 1

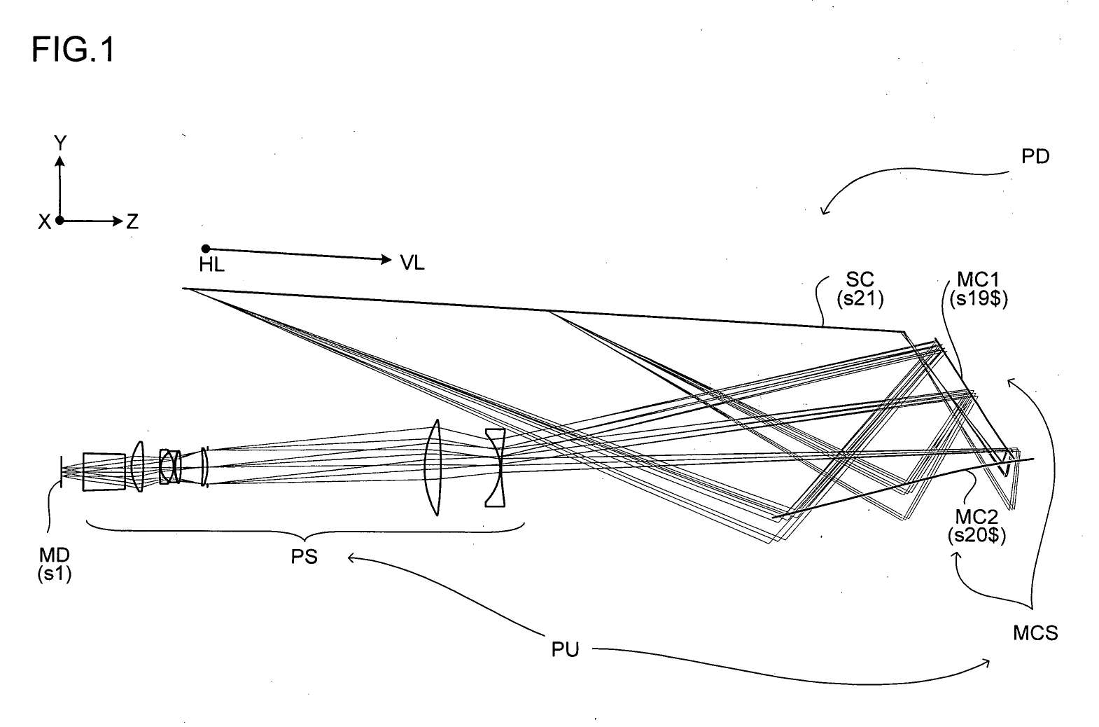

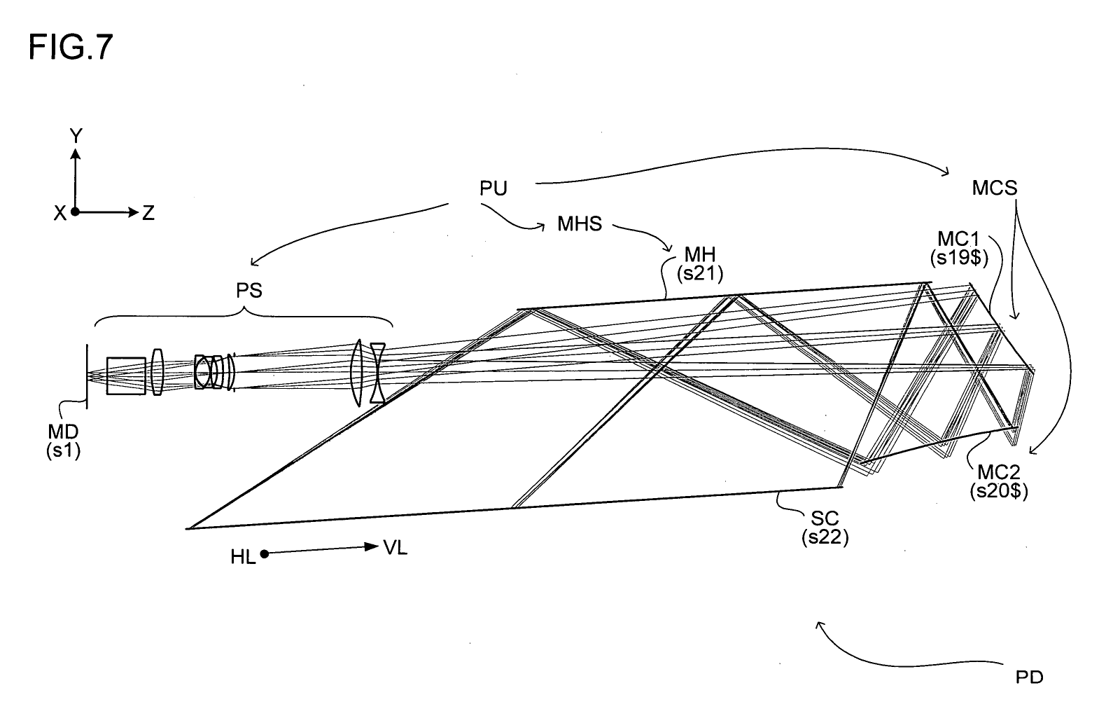

Hereinafter, examples (Examples 1 and 2) embodying the invention will be described with reference to the drawings; more specifically, Example 1 will be described with reference to FIGS. 1 to 6, and Example 2 will be described with reference to FIGS. 7 to 12.

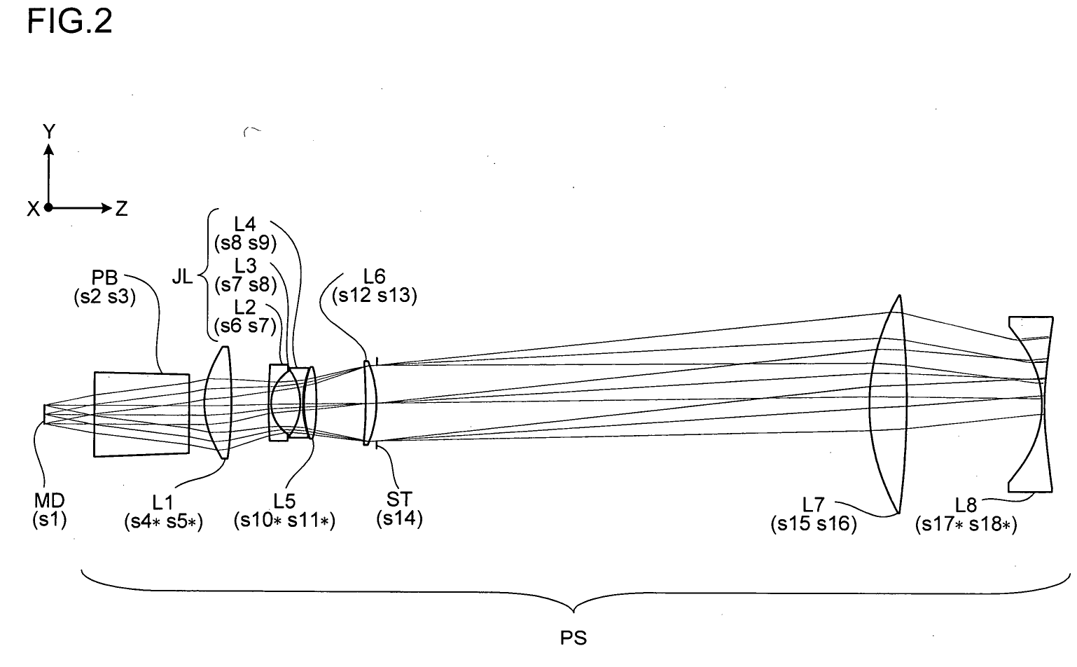

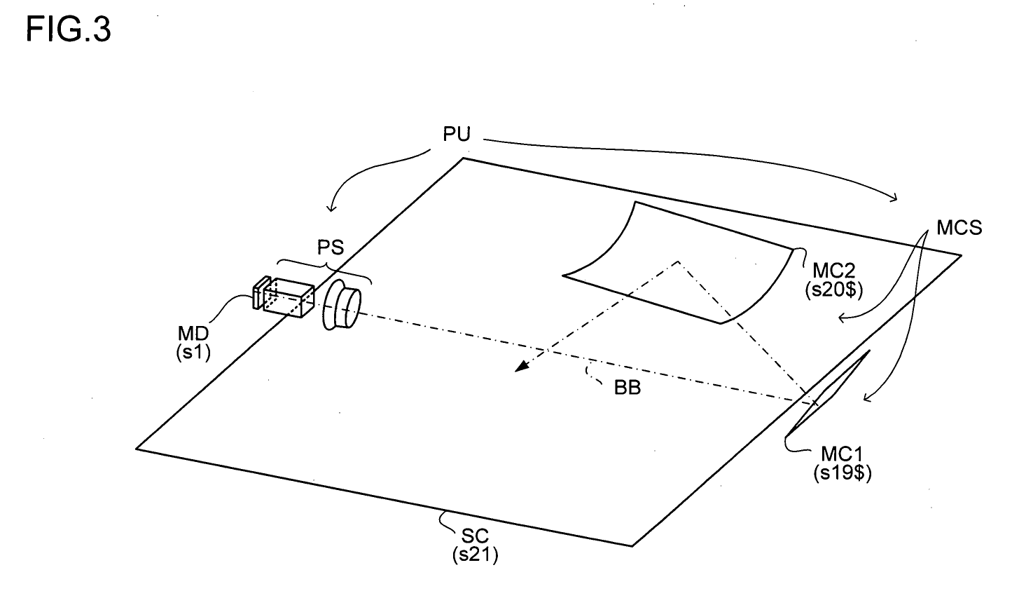

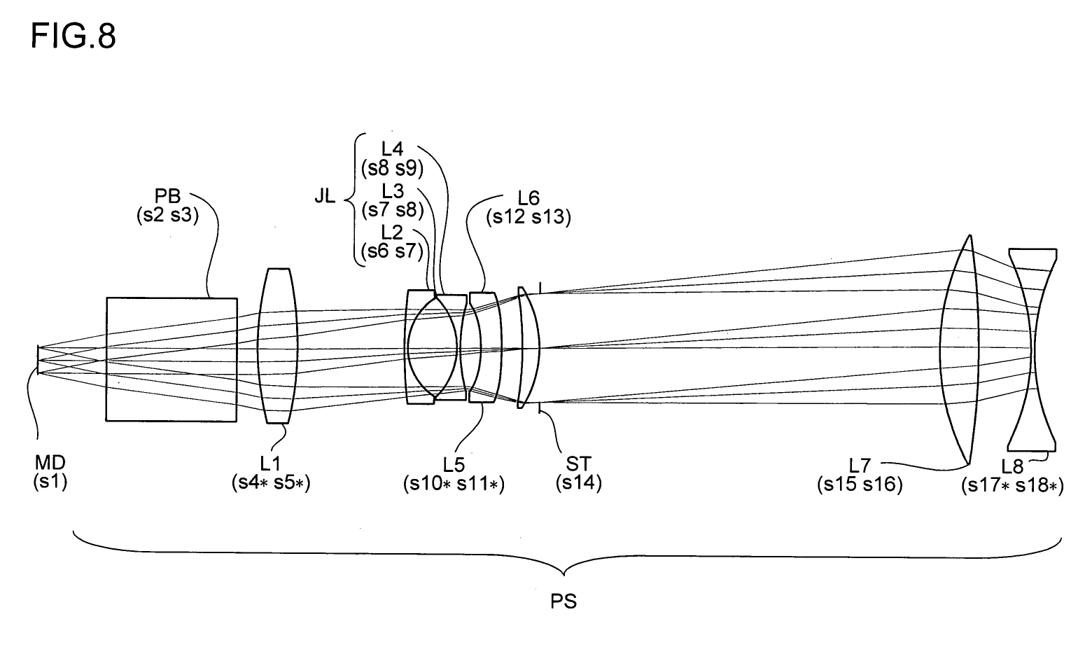

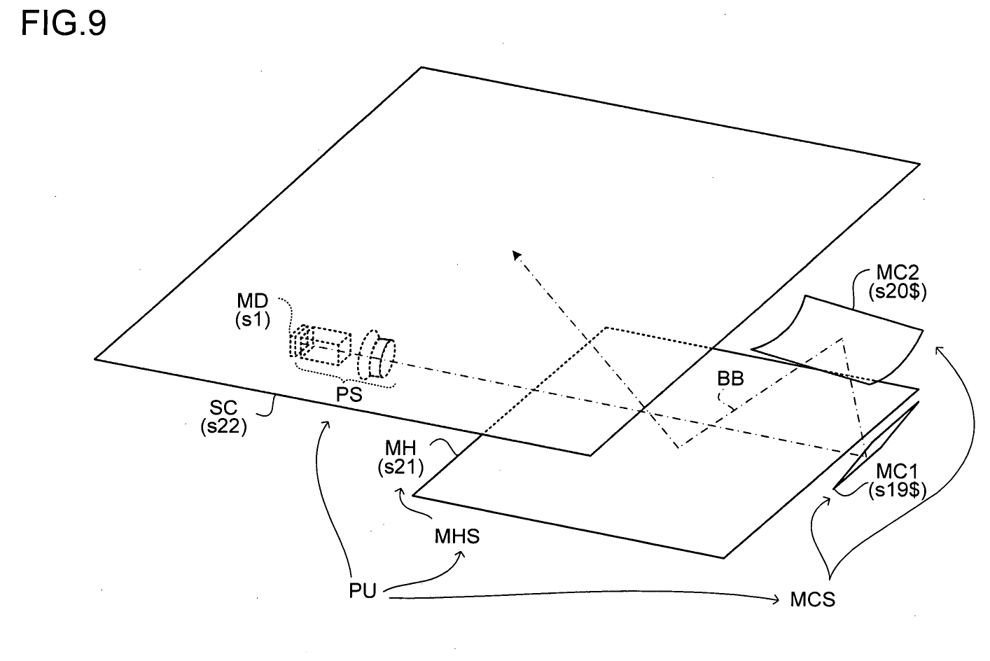

FIGS. 3 and 9 are schematic perspective views of the projectors PD of Examples 1 and 2 respectively. FIGS. 1 and 7 are schematic optical cross-sectional views (in a Y-Z cross-section in the later described global coordinate system) of the projectors PD of Examples 1 and 2 respectively. FIGS. 2 and 8 are schematic optical cross-sectional views showing, mainly, the projection optical system unit PU (described later) in the projectors PD of Examples 1 and 2 respectively.

In the projector PD of each example, an optically acting surface is referred to by the symbol “si”, where “i” is the number (i=1, 2, 3, . . . ) of the surface as counted from a light modulation element MD (the reduction side) to a screen SC (the enlargement side) (see FIGS. 2 and 8, among others). If an optically acting surface has an aspherical shape, its symbol is marked with an asterisk “*”; if an optically acting surface has a free-form curved shape, its symbol is marked with an dollar sign “$”. The ray traveling from the center of the panel display surface of the light modulation element MD through the center of an optical aperture ST to the center of the screen surface (projection surface) is referred to as the base ray BB (see FIGS. 3 and 9).

### 1-1. Projector

The projectors PD shown in FIGS. 1 and 7 are one example of image projection apparatuses. These projectors PD include a projection optical system unit PU that guides image light emitted from the light modulation element MD so as to project the image light onto the screen SC (projection surface).

The light modulation element MD receives light (illumination light) from an unillustrated illumination optical system, and modulates the light (received rays) according to, for example, image data (the so modulated light is called image light). Used as the light modulation element MD is, for example, a DMD (Digital Micromirror Device, manufactured by Texas Instruments Incorporated) or a LCOS (liquid crystal on silicon) device. The panel display surface of the light modulation element MD is referred to by the symbol “s1”.

In Example 1, the projection optical system unit PU at least includes a positively powered optical system PS that has such an optical power as to make the image light converge and a curved-mirror optical system MCS that has a plurality of curved mirrors MC. In Example 2, the projection optical system unit PU at least includes a positively powered optical system PS, a curved-mirror optical system MCS, and a turning mirror optical system MHS.

In both Examples 1 and 2, the positively powered optical system PS guides the image light traveling from the light modulation element MD to the curved-mirror optical system MCS. As shown in FIGS. 2 and 8, the positively powered optical system PS includes a prism block PB, a first lens element L1, a joined lens element JL (a second lens element L2, a third lens element L3, and a fourth lens element L4), a fifth lens element L5, a sixth lens element L6, an optical aperture ST, a seventh lens element L7, and an eighth lens element L8.

More detailedly, these optical components have the following specifications:
Prism Block PB A prism having at least two surfaces (s2 and s3); it may be shared as a color integration prism or as a PBS (polarized beam splitter).
First Lens Element L1 A positive lens element convex on both sides (on the reduction and enlargement sides).
Joined Lens Element JL A lens element having a second lens element L2, a third lens element L3, and a fourth lens element L4 jointed together with, for example, adhesive; the second lens element L2 is a negative meniscus lens element convex on the reduction side; the third lens element L3 is a positive lens element convex on both sides; the fourth lens element L4 is a negative lens element concave on both sides.
Fifth Lens Element L5 In Example 1, a positive lens element convex on both sides (see FIG. 2); in Example 2, a negative meniscus lens element concave on the reduction side (see FIG. 8).
Sixth Lens Element L6 A positive meniscus lens element concave on the reduction side.
Optical Aperture ST An aperture that intercepts part of the image light; it is referred to also by “s14”.
Seventh Lens Element L7 A positive lens element convex on both sides.
Eighth Lens Element L8 A negative lens element concave on both sides.

The positively powered optical system PS is not limited to an optical system built solely with a prism block PB and lenses; it may be, for example, an optical system that includes mirrors alone, or an optical system that includes lenses and mirrors.

In Example 1, the curved-mirror optical system MCS guides the image light traveling from the positively powered optical system PS to the screen SC. In Example 2, the curved-mirror optical system MCS guides the image light traveling from the positively powered optical system PS to the turning mirror optical system MHS.

The curved-mirror optical system MCS includes a first curved mirror MC1 that reflects the image light from the positively powered optical system PS, and a second curved mirror MC2 that reflects the image light reflected from the first curved mirror MC1. Here, the reflective surface of the second curved mirror MC2 is convex, and thus exerts a negative optical power.

In Example 2, the projection optical system unit PU includes the turning mirror optical system MHS that guides the image light from the curved-mirror optical system MCS to the screen SC. In Example 2, the turning mirror optical system MHS is built with a single flat mirror MH. Thus, the turning mirror optical system MHS only once turns (by reflecting) the image light from the second curved mirror MC2 and thereby guides the image light to the screen SC (the turning mirror optical system MHS may include a plurality of turning mirrors).

### 1-2. Construction Data of the Projector

The construction data of the projectors PD of Examples 1 and 2 is listed in Tables 1 to 25. In these tables, the following symbols are used:

The symbol “si” represents an optically acting surface, where “i” represents the order as counted from the light modulation element MD (s1) to the screen SC (screen surface).

The symbol “ri” represents the radius of curvature (in mm) of an optically acting surface, where “i” represents the order as noted above.

The symbol “di” represents an axial, surface-to-surface distance (in mm), where “i” represents the order as noted above. For a decentered (eccentric) optically acting surface, however, no axial distance is given, since its position is represented by translational and rotational decentering displacements (described later).

The symbol “Ni” represents an index of refraction Nd for the d-line, where “i” represents the order as noted above.

The symbol “νi” represents an Abbe number νd for the d-line, where “i” represents the order as noted above.

The symbols “XDE”, “YDE”, “ZDE”, “ADE”, “BDE”, and “CDE” represent translational and rotational decentering displacements, as measured in a global, right-hand, rectangular coordinate system (global coordinates “(X, Y, Z)”) whose origin is at the center of the panel display surface s1 of the light modulation element MD and whose Z-axis runs from the origin in the direction normal to the panel display surface s1 (the X-axis corresponding to the thumb, the Y-axis the index finger, and the Z-axis the middle finger). More specifically, “XDE”, “YDE”, and “ZDE” represent the coordinates (in mm) of the vertex of an optically acting surface as measured in the global coordinate system, individually indicating the translational decentering displacement in the X, Y, and Z directions respectively. On the other hand, “ADE”, “BDE”, and “CDE” represent the angles of rotation (in degrees) of the optically acting surface about its vertex, individually indicating the rotational decentering displacement about the X-, Y- and Z-axis respectively. Here, a “positive” angle denotes, for “ADE” and “BDE”, a counter-clockwise rotation with respect to the positive X or Y direction and, for “CDE”, a clockwise rotation with respect to the positive Z direction.

The symbols “K”, “A”, “B”, “C”, and “D” represent aspherical surface data. When an optically acting surface has an aspherical surface, the aspherical surface is defined by formula (AS) below in a local, right-hand, rectangular coordinate system (local coordinates “(x, y, z)”) whose origin is at the vertex of the optically acting surface and whose z-axis runs from the origin in the direction normal to the optically acting surface.

$$z = c \cdot {h}^{2} / \{ 1 + \sqrt{1 - ( 1 + k ) \cdot {c}^{2} \cdot {h}^{2}} \} + A \cdot {h}^{4} + B \cdot {h}^{6} x + C \cdot {h}^{8} + D \cdot {h}^{10} + E \cdot {h}^{12} + F \cdot {h}^{14} + G \cdot {h}^{16} + H \cdot {h}^{18} + J \cdot {h}^{20} \qquad ( AS )$$

where
z represents the displacement in the z-axis direction at the position (x, y), with respect to the vertex;
h represents the height in a direction perpendicular to the z-axis (h²=x²+y²);
c represents the paraxial curvature (which equals the reciprocal of the radius of curvature);
k represents the conic constant; and
A, B, C, D, E, F, G, H, I, and J represent aspherical surface coefficients.

### Accordingly, listed as aspherical surface data are the values of aspherical surface coefficients that have non-zero values (namely “A”, “B”, “C”, and “D”). The symbol “E-n” stands for “10⁻ⁿ”.

The symbol C(m, n) represents free-form surface data. When an optically acting surface has a free-form curved surface, the free-form curved surface is defined by formula (FS) below in a local, right-hand, rectangular coordinate system (local coordinates “(x, y, z)”) whose origin is at the vertex of the optically acting surface and whose z-axis runs from the origin in the direction normal to the optically acting surface.

$$z = c \cdot {h}^{2} / \{ 1 + \sqrt{1 - ( 1 + k ) \cdot {c}^{2} \cdot {h}^{2}} \} + {\sum }_{j = 2}^{66} {C}_{j} \cdot {x}^{m} \cdot {y}^{n} \qquad ( FS )$$

where
z represents the displacement in the z-axis direction at the position (x, y), with respect to the vertex;
h represents the height in a direction perpendicular to the z-axis (h²=x²+y²);
c represents the paraxial curvature (which equals the reciprocal of the radius of curvature);
k represents the conic constant (for a free-form surface, k=0); and
Cⱼ represent the free-form surface coefficient (where j=[(m+n)²+m+3n]/2+1).

### Accordingly, listed as free-form surface data is the value of the free-form surface coefficient Cj(=C(m, n)). The symbol “E-n” stands for “10⁻ⁿ”.

### 1-3. Spot Diagrams and Distortion Diagrams

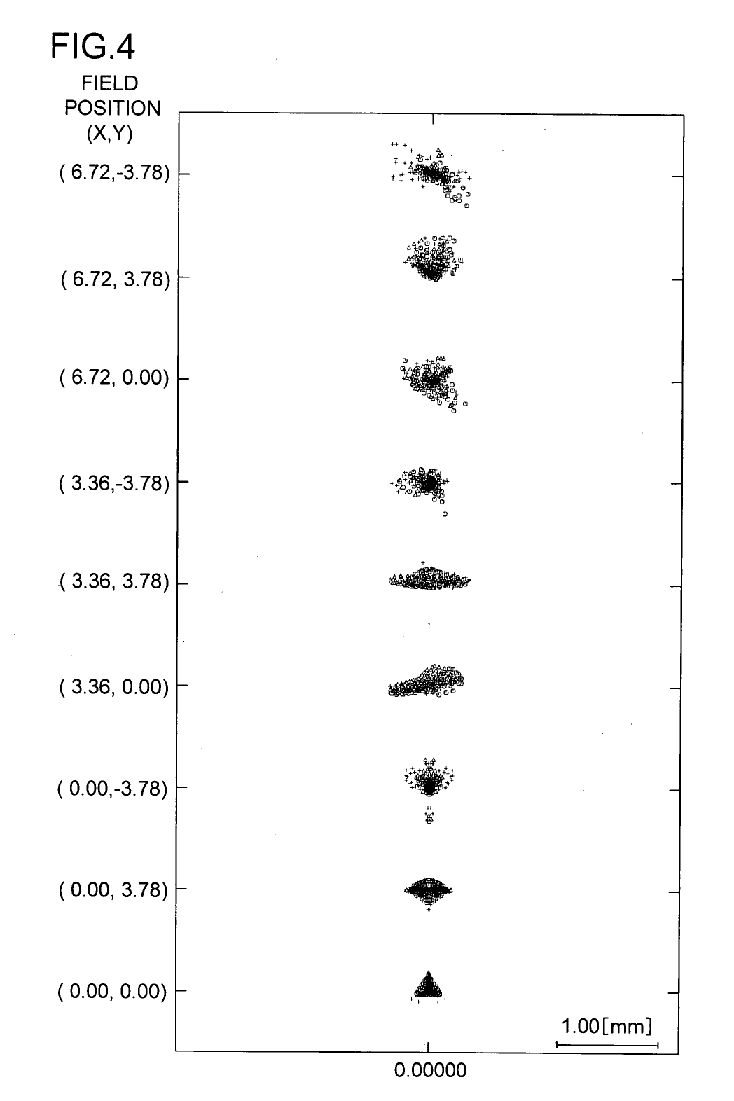

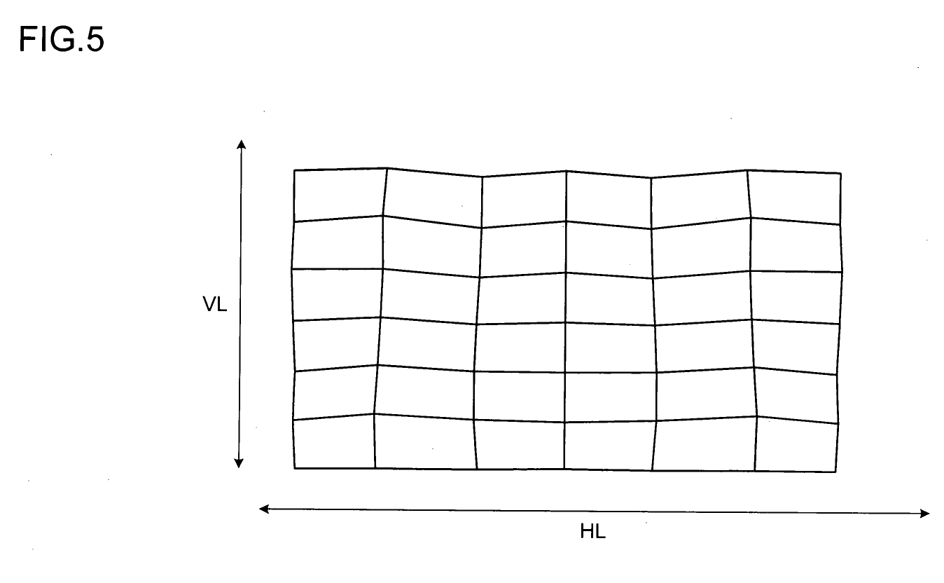

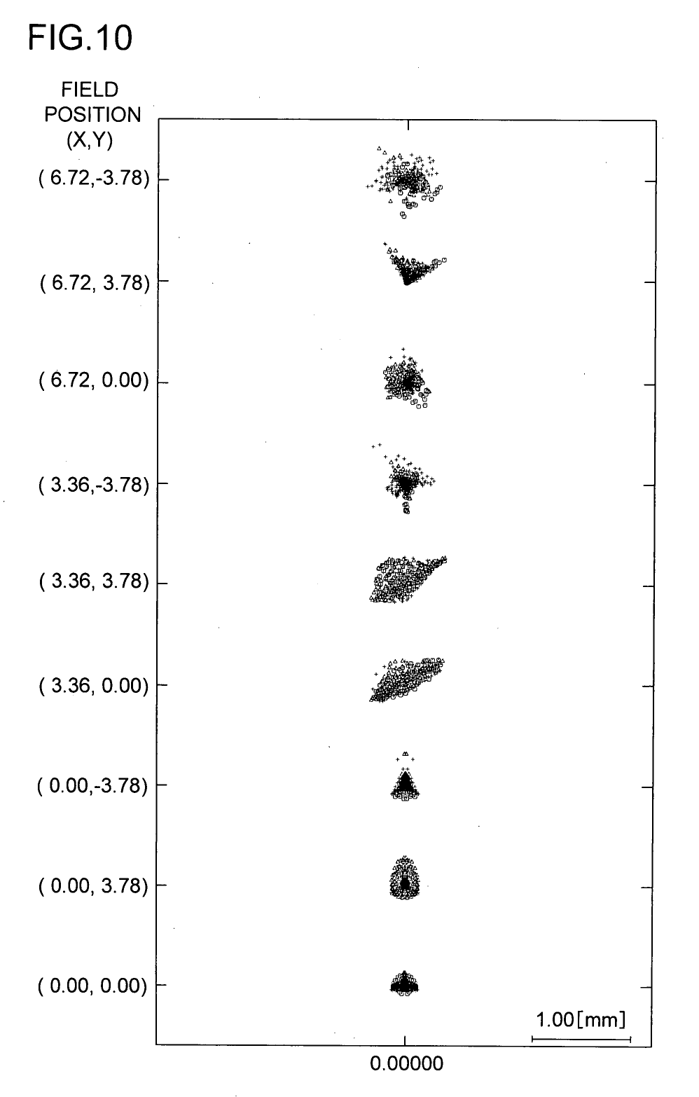

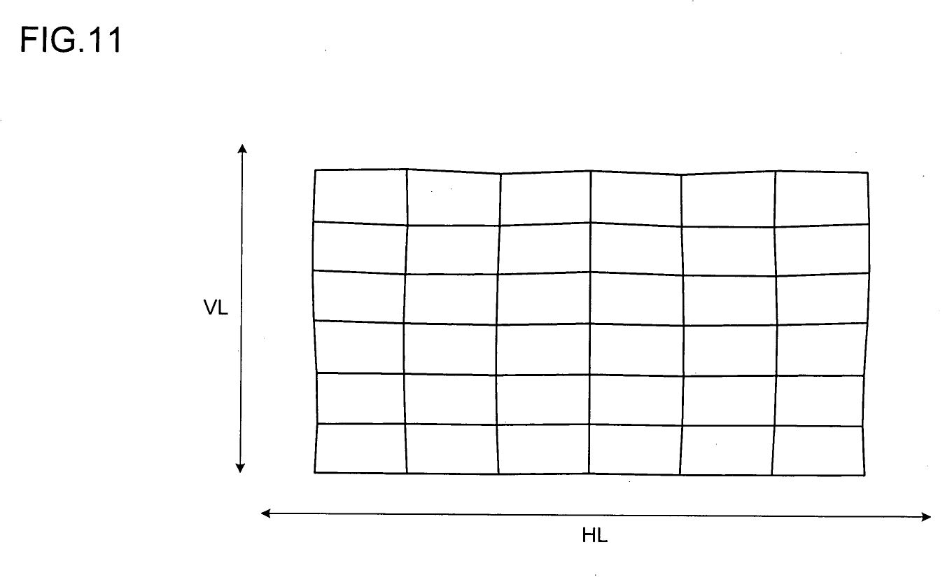

The optical performance of the projectors PD of Examples 1 and 2 is shown in the form of spot diagrams (see FIGS. 4 and 10 respectively) and distortion diagrams (see FIGS. 5 and 11 respectively). The spot diagrams of FIGS. 4 and 10 show the imaging characteristics (in mm) with the d-, g-, and c-lines on the screen surface. In these diagrams “FIELD POSITION(X, Y)” denotes the position on the panel display surface where light passes through it.

The distortion diagrams of FIGS. 5 and 11 show the distortion of the light image on the screen surface. On the screen surface, a rectangular coordinate system (HL, HV) is defined of which the direction of one axis is called the horizontal direction HL and the direction of the other axis is called the vertical direction VL. Here, the horizontal-direction (HL) axis points in the same direction as the x-axis of the local coordinate system on the screen surface, and the vertical-direction (VL) axis points in the same direction as the y-axis of the local coordinate system on the screen surface.

In the projector PD of Example 1, the object-side f-number (FNo.) is 2.50; the magnification factors (image magnifications β(x) and β(y)) in the x- and y-axis directions of the local coordinate system on the screen surface is −85.9 and −85.6 respectively. The reason that the image magnifications bear the negative (minus) sign is that the x- and y-axis directions are reversed between the different local coordinate systems.

In Example 2, the object-side f-number (FNo.) is 2.50; the magnification factors (image magnifications β(x) and β(y)) in the x- and y-axis directions of the local coordinate system on the screen surface is −86.1 and −85.5 respectively.

### 1-4. Examples of Features

As described above, the projector PD includes a projection optical system unit PU that guides the image light emitted from a light modulation element MD so as to project the image light onto a screen surface. And this projection optical system unit PU at least includes a positively powered optical system PS and a curved-mirror optical system MCS.

The positively powered optical system PS is located between the light modulation element MD and the screen SC, and transmits the image light traveling from the light modulation element MD to the screen SC. Thus, the positively powered optical system PS makes the image light converge.

Accordingly, for example, in a case where the length direction of the positively powered optical system PS (the direction in which its lens elements are arranged) is substantially perpendicular to the thickness (depth) direction of the projector PD as shown in FIGS. 1 and 7, the thickness of the light beam exiting from the positively powered optical system PS does not add to the depth of the image projection apparatus. This is because, in such an arrangement, the direction in which the positively powered optical system makes the light beam converge coincides with the thickness direction of the projector PD.

Moreover, with its optical power (refractive power), the positively powered optical system PS corrects for aberrations (such as chromatic aberration and distortion). For example, in a case where the light modulation element MD is a three-panel LCOS device, a color integration prism is used to integrate three colors together, and this produces chromatic aberration. In that case, the incorporation of the positively powered optical system PS in the projection optical system unit PU makes it possible to correct for chromatic aberration with the different lens elements in the positively powered optical system PS.

The projection optical system unit PU also includes the curved-mirror optical system MCS, and this curved-mirror optical system MCS has a plurality of curved mirrors MC (specifically, a first curved mirror MC1 and a second curved mirror MC2). The incorporation of these curved mirrors MC in the curved-mirror optical system MCS allows the image light to undergo reflection on them while traveling forward. This makes it possible to correct for curvature of field and distortion efficiently with curved reflective surfaces.

In particular, in a case where a plurality of curved mirrors MC are involved, aberrations (curvature of field and distortion) can be corrected for as much more effectively as the number of extra curved mirrors than with a single curved mirror. Correcting aberrations with a single curved mirror, and hence with a single reflective surface, requires that the reflective surface has a comparatively large area; by contrast, correcting aberrations with a plurality of curved mirrors allows the burden of aberration correction to be shared among the curved mirrors MC, and thus allows their reflective surfaces to have comparatively small areas.

In addition, the optical path from the light modulation element MD to the screen SC (screen surface) is turned by the curved-mirror optical system MCS. This prevents the projection optical system unit PU from extending in one direction as does a straight optical system. Thus designed to be compact, the projection optical system unit PU can be easily incorporated in the projector PD.

One example of a compactly designed projection optical system unit PU is one in which the first and second curved mirrors MC1 and MC2 are arranged (located) such that the optical path of the base ray BB reaching the first curved mirror MC1 crosses the optical path of the base ray BB leaving the second curved mirror MC2 (these optical paths may cross each other “spatially”).

With such an arrangement, for example as shown in FIGS. 1 and 7, the following three optical paths lie substantially in the shape of the figure “4”: the optical path (optical path 1) of the image light reaching the first curved mirror MC1; the optical path (optical path 2) from the first curved mirror MC1 to the second curved mirror MC2; and the optical path (optical path 3) of the image light leaving the second curved mirror MC2. Here, the vertical stroke of the figure “4” corresponds to optical path 1, the diagonal stroke to optical path 2, and the horizontal stroke to optical path 3 (and, what is considered to be located at the free end of the horizontal stroke is, in Example 1, the screen and, in Example 2, the turning flat mirror MH).

Thus, provided that optical path 1 points substantially in the same direction as (is substantially parallel to) the vertical direction VL of the screen SC (the direction perpendicular to the thickness direction of the screen SC and running along the shorter sides of its screen surface), the thickness of the projector PD is affected mainly by optical path 3, the comparatively short one. Accordingly, with the arrangement described above, the projector PD is slim.

Laying optical paths 1 to 3 in the shape of the figure “4” also provides the advantage of making it easy to arrange the first and second curved mirrors MC1 and MC2 next to each other at the back of the screen SC (see FIGS. 1 and 7).

Moreover, the second curved mirror MC2 in the projection optical system unit PU exerts a negative optical power. This makes the image light traveling from the second curved mirror MC2 diverge while it is guided to the screen SC (screen surface). Guiding the image light to the screen surface while making it diverge results in a comparatively short optical path.

The reason is as follows. To obtain a standardized image size on the screen surface, whereas non-divergent image light requires a long optical path exactly because it is not divergent, a short optical path will do with divergent image light. Accordingly, with a projection optical system unit PU that can emit not non-divergent image light but divergent image light toward the screen or the turning flat mirror MH, it is easier to make the projector PD less deep.

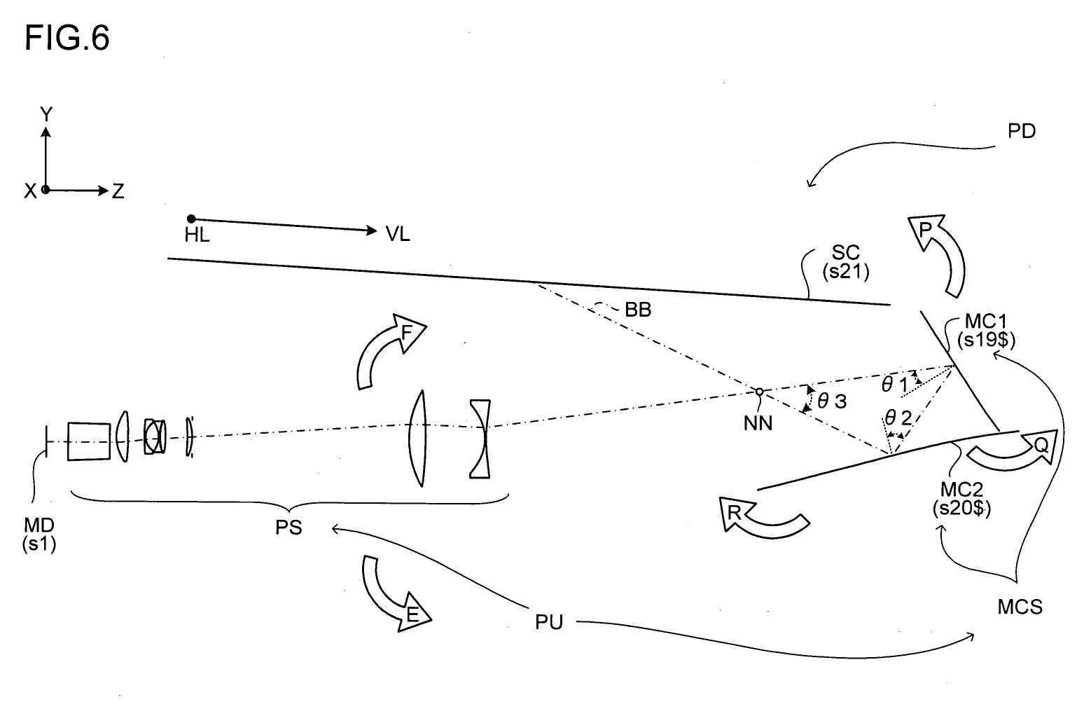

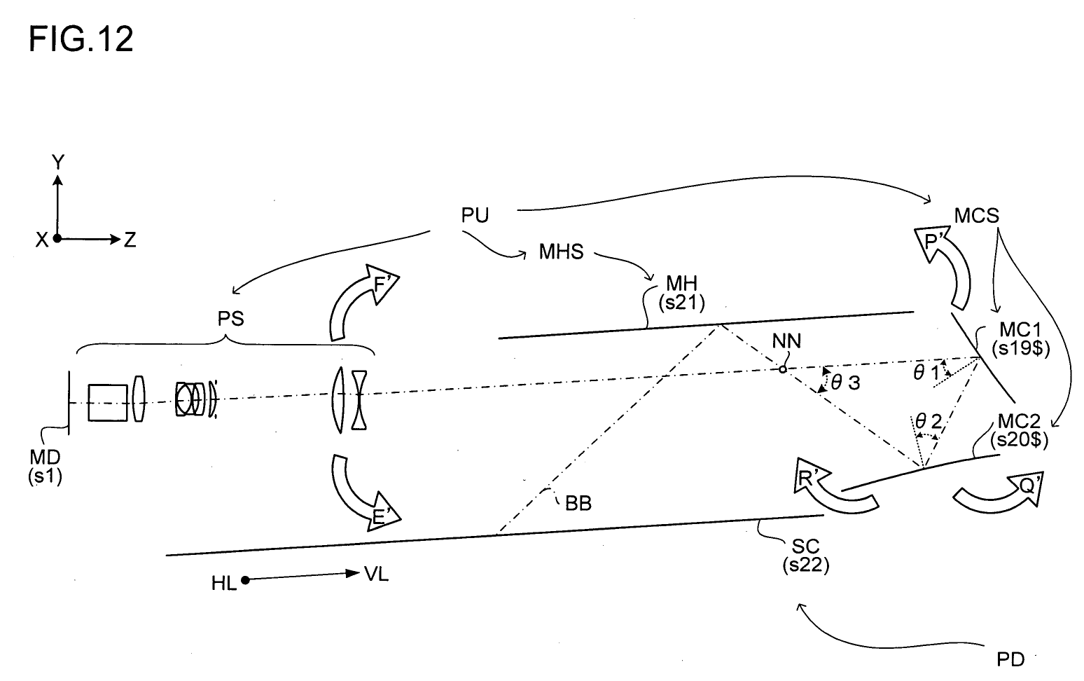

Moreover, in the projector PD, appropriately setting the relevant angles (θ1 to θ3) shown in FIGS. 6 and 12 leads to further slimness (or compactness) and higher performance (reduced aberrations). For example, it is preferable that the projector PD fulfill formula (1) below.

### 1-4-1. Conditional Formula (1)

15<θ1<45 (1)

where
θ1 represents the angle of incidence (in degrees) at which the base ray BB reaches the first curved mirror MC1.

### 1-4-1-1. In the Projector PD of Example 1

For example, in Example 1 shown in FIG. 6, as the positively powered optical system PS moves (changes its position by rotating, or sliding, or both rotating and sliding) in the direction indicated by arrow E, the value of conditional formula (I) may become equal to or smaller than the lower limit. When this happens, inconveniently, part of the image light exiting from the positively powered optical system PS is intercepted by (interferes with) the second curved mirror MC2.

On the other hand, as the positively powered optical system PS moves in the direction indicated by arrow F, the value of conditional formula (1) may become equal to or greater than the upper limit. When this happens, the positively powered optical system PS is so close to the screen SC that an unduly large part of the positively powered optical system PS protrudes from behind the back side of the screen surface (forming a chin-like projection with an unduly great overhang length).

Hence, setting the value of θ1 within the range defined by conditional formula (1) helps prevent the projector PD from encountering a situation where part of the image light does not reach the screen surface, and also helps prevent an unduly large chin-like projection.

It is further preferable that, within the range defined by conditional formula (1), the range defined by conditional formula (1a) below be fulfilled.

20<θ1<35 (1a)

For example, if the value of conditional formula (1a) is equal to or smaller than the lower limit, certainly it is unlikely that part of the light exiting from the positively powered optical system PS is intercepted by the second curved mirror MC2; however, as a result of the positively powered optical system PS moving and settling in the direction indicated by arrow E, the projector PD is unduly thick.

On the other hand, if the value of conditional formula (1a) is equal to or greater than the upper limit, certainly it is unlikely that the positively powered optical system PS comes so close to the screen SC as to form an unduly large chin-like projection; however, as a result of the image light reaching the first curved mirror MC1 at a comparatively large angle of incidence, trapezoid distortion occurs.

Hence, setting the value of θ1 within the range defined by conditional formula (1a) helps make the projector PD small in thickness (depth) while suppressing distortion and other aberrations.

In the projector PD of Example 1, the value of θ1 is 24.200 degrees, which falls within the ranges defined by both conditional formulae (1) and (1a).

### 1-4-1-2. In the Projector PD of Example 2

In Example 2 shown in FIG. 12, as the positively powered optical system PS moves in the direction indicated by arrow E′, the value of conditional formula (1) may become equal to or smaller than the lower limit. When this happens, inconveniently, as in Example 1, part of the image light exiting from the positively powered optical system PS is intercepted by (interferes with) the second curved mirror MC2.

On the other hand, as the positively powered optical system PS moves in the direction indicated by arrow F′, the value of conditional formula (1) may become equal to or greater than the upper limit. When this happens, unlike in Example 1, the positively powered optical system PS is so far away from the screen SC that the projector PD is unduly thick.

Hence, in Example 2, setting the value of θ1 within the range defined by conditional formula (1) helps prevent the projector PD from encountering a situation where part of the image light does not reach the screen surface, and also helps prevent an unduly large thickness.

In the projector PD of Example 2, for example, if the value of conditional formula (1a) is equal to or smaller than the lower limit, certainly it is unlikely that part of the light exiting from the positively powered optical system PS is intercepted by the second curved mirror MC2; however, as a result of the positively powered optical system PS moving and settling in the direction indicated by arrow E′, an unduly large chin-like projection is formed.

On the other hand, if the value of conditional formula (1a) is equal to or greater than the upper limit, certainly it is unlikely that the positively powered optical system PS comes so far away from the screen SC as to make the projector PD unduly thick; however, as a result of the image light reaching the first curved mirror MC1 at a comparatively large angle of incidence, trapezoid distortion occurs.

Hence, setting the value of θ1 within the range defined by conditional formula (1a) helps prevent an unduly large chin-like projection while suppressing distortion and other aberrations.

In the projector PD of Example 2, the value of θ1 is 30.100 degrees, which falls within the ranges defined by both conditional formulae (1) and (1a).

### 1-4-2. Conditional Formula (2)

It is preferable that the projector PD fulfill formula (2) below.

30<θ2<60 (2)

where
θ2 represents the angle of incidence (in degrees) at which the base ray BB reaches the second curved mirror MC2.

### 1-4-2-1. In the Projector PD of Example 1

For example, in Example 1 shown in FIG. 6, as the first curved mirror MC1 moves in the direction indicated by arrow P, the value of conditional formula (2) may become equal to or smaller than the lower limit. If this happens, inconveniently, the first curved mirror MC1 collides with the screen SC.

On the other hand, as the second curved mirror MC2 moves in the direction indicated by arrow Q, the value of conditional formula (2) may become equal to or greater than the lower limit. If this happens, the maximum distance between the second curved mirror MC2 and the screen SC, and hence the chin-like projection, is unduly long.

Hence, setting the value of θ2 within the range defined by conditional formula (2) allows the first curved mirror MC1 and the screen SC to be arranged properly, and also helps prevent an unduly large chin-like projection.

It is further preferable that, within the range defined by conditional formula (2), the range defined by conditional formula (2a) below be fulfilled.

35<θ2<55 (2a)

For example, as the second curved mirror MC2 moves in the direction indicated by arrow R, the value of conditional formula (2a) may become equal to or smaller than the lower limit. If this happens, the image light traveling from the second curved mirror MC2 is no longer projected obliquely with respect to the screen surface (it is now projected perpendicularly instead). Thus, to obtain a standardized image size, the distance between the second curved mirror MC2 and the screen SC needs to be increased, and this makes it impossible to make the projector PD slim.

On the other hand, if the value of conditional formula (2a) is equal to or than the upper limit, certainly it is unlikely that the second curved mirror MC2 so moves as to form an unduly large chin-like projection as described above; however, as a result of the image light reaching the second curved mirror MC2 at a comparatively large angle of incidence, trapezoid distortion occurs.

Hence, setting the value of θ2 within the range defined by conditional formula (2a) helps realize a high-performance projector PD that is slim but nevertheless operates with suppressed distortion.

In the projector PD of Example 1, the value of θ2 is 48.846 degrees, which falls within the ranges defined by both conditional formulae (2) and (2a).

### 1-4-2-2. In the Projector PD of Example 2

In Example 2 shown in FIG. 12, for example, as the first curved mirror MC1 moves in the direction indicated by arrow P′, the value of conditional formula (2) may become equal to or smaller than the lower limit. If this happens, unlike in Example 1, the first curved mirror MC1 may collide with the turning flat mirror MH.

On the other hand, as the second curved mirror MC2 moves in the direction indicated by arrow Q′, the value of conditional formula (2) may become equal to or greater than the upper limit. If this happens, as in Example 1, the maximum distance between the second curved mirror MC2 and the screen SC, and hence the chin-like projection, is unduly long.

Hence, in Example 2, setting the value of θ2 within the range defined by conditional formula (2) allows the first curved mirror MC1 and the turning flat mirror MH to be arranged properly, and also helps prevent an unduly large chin-like projection.

In the projector PD of Example 2, for example, as the second curved mirror MC2 moves in the direction indicated by arrow R′, the value of conditional formula (2a) may become equal to or smaller than the lower limit. If this happens, the image light traveling from the second curved mirror MC2 is no longer projected obliquely with respect to the turning flat mirror MH. Thus, to obtain a standardized image size, the distance between the second curved mirror MC2 and the turning flat mirror MH, or the distance between the turning flat mirror MH and the screen SC, needs to be increased, and this makes it impossible to make the projector PD slim.

On the other hand, if the value of conditional formula (2a) is equal to or greater than the upper limit, certainly it is unlikely that the second curved mirror MC2 so moves as to form an unduly large chin-like projection as described above; however, as a result of the image light reaching the turning flat mirror MH at a comparatively large angle of incidence, trapezoid distortion occurs.

Hence, setting the value of θ2 within the range defined by conditional formula (2a) helps realize a high-performance projector PD that is slim but nevertheless operates with suppressed distortion.

In the projector PD of Example 2, the value of θ2 is 39.700 degrees, which falls within the ranges defined by both conditional formulae (2) and (2a).

### 1-4-3. Conditional Formula (3)

It is preferable that the projector PD fulfill formula (3) below.

25<θ3<50 (3)

where
θ3 represents the angle (in degrees) between the direction in which the base ray BB travels to reach the first curved mirror MC1 and the direction in which the base ray BB travels to leave the second curved mirror MC2.

Let the intersection between the direction in which the base ray BB travels to reach the first curved mirror MC1 and the direction in which the base ray BB travels to leave the second curved mirror MC2 be called the intersection NN. Then, the angle θ3 is the angle (acute angle) between the optical path BB from the intersection NN to the first curved mirror MC1 and the optical path BB from the second curved mirror MC2 to the intersection NN.

### 1-4-3-1. In the Projector PD of Example 1

In Example 1 shown in FIG. 6, for example, as the positively powered optical system PS moves in the direction F, the value of conditional formula (3) may become equal to or smaller than the lower limit. If this happens, whereas the positively powered optical system PS comes close to the back side of the screen SC, the optical path from the second curved mirror MC2 to the screen SC slides toward the positively powered optical system PS. As a result, this optical path interferes with the positively powered optical system PS, and thus, inconveniently, the image light is intercepted by the positively powered optical system PS.

On the other hand, as the positively powered optical system PS moves in the direction E, the value of conditional formula (3) may become equal to or greater than the upper limit. If this happens, the distance between the positively powered optical system PS and the screen SC is unduly great, and accordingly the projector PD is unduly thick.

Hence, setting the value of θ3 within the range defined by conditional formula (3) helps prevent the projector PD from encountering a situation where part of the image light does not reach the screen surface, and also helps prevent an unduly large thickness.

It is further preferable that, within the range defined by conditional formula (3), the range defined by conditional formula (3a) below be fulfilled.

30<θ3<45 (3a)

For example, if the value of conditional formula (3a) is equal to or smaller than the lower limit, certainly it is unlikely that the optical path from the second curved mirror MC2 to the coordinate system interferes with the positively powered optical system PS as described above; however, as a result of the positively powered optical system PS moving and settling in the direction indicated by arrow F, an unduly large chin-like projection is formed.

On the other hand, if the value of conditional formula (3a) is equal to or greater than the upper limit, certainly it is unlikely that an unduly great distance between the positively powered optical system PS and the screen SC makes the projector PD unduly thick; however, the increase in the angle θ3 produces an increase in the distance between the first and second curved mirrors MC1 and MC2, and this increase makes the projector PD unduly thick.

Hence, setting the value of θ3 within the range defined by conditional formula (3a) helps reduce the thickness of the projector PD while preventing it from having an unduly large chin-like projection.

In the projector PD of Example 1, the value of θ3 is 34.000 degrees, which falls within the ranges defined by both conditional formulae (3) and (3a).

### 1-4-3-2. In the Projector PD of Example 2

In Example 2 shown in FIG. 12, for example, as the positively powered optical system PS moves in the direction F′, the value of conditional formula (3) may become equal to or smaller than the lower limit. If this happens, the turning flat mirror MH is located in the optical path between the positively powered optical system PS and the first curved mirror MC1. Thus, inconveniently, the image light from the positively powered optical system PS is intercepted by the turning flat mirror MH.

On the other hand, as the positively powered optical system PS moves in the direction E′, the value of conditional formula (3) may become equal to or greater than the upper limit. If this happens, the positively powered optical system PS is so close to the screen SC as to form an unduly large chin-like projection.

Hence, in Example 2, setting the value of θ3 within the range defined by conditional formula (3) helps prevent a situation where part of the image light does not reach the screen surface, and also helps prevent an unduly large chin-like projection.

In the projector PD of Example 2, for example, if the value of conditional formula (3a) is equal to or smaller than the lower limit, certainly it is unlikely that the image light exiting from the positively powered optical system PS interferes with the turning flat mirror MH; however, as a result of the positively powered optical system PS moving and settling in the direction indicated by arrow F′, inconveniently, the projector PD is unduly thick.

On the other hand, if the value of conditional formula (3a) is equal to or greater than the upper limit, certainly it is not likely that excessive closeness of the positively powered optical system PS to the screen SC forms an unduly large chin-like projection as described above; however, as in Example 1, the increase in the angle θ3 produces an increase in the distance between the first and second curved mirrors MC1 and MC2, and this increase makes the projector PD unduly thick.

Hence, in Example 2, setting the value of θ3 within the range defined by conditional formula (3a) helps make the projector PD slim while preventing it from having an unduly large chin-like projection.

In the projector PD of Example 2, the value of θ3 is 40.300 degrees, which falls within the ranges defined by both conditional formulae (3) and (3a).

### 1-4-4. Conditional Formula (4)

The projector PD achieves enlargement projection of the image light with the optical powers (refractive powers) of the curved mirrors MC. Thus, by appropriately setting the optical power of the curved mirrors MC, it is possible to achieve higher performance (better-corrected (suppressed) aberrations) and further slimness (or compactness). From this perspective, it is preferable that the projector PD fulfill the conditional formulae noted below.

For example, it is preferable that the projector PD fulfill conditional formula (4) below.

1.0<H×r(MC1)<3.0 (4)

where
H represents the length (in mm) of the screen surface in one direction (horizontal direction HL) in the rectangular coordinate system defined on the screen surface; and
r(MC1) represents the curvature (in mm⁻¹) of the reflective surface of the first curved mirror MC1 at the point on it where the base ray BB reaches it, as measured in the same direction on the reflective surface as the horizontal direction HL (i.e. the x-axis direction of the local coordinate system), the curvature being given a positive sign if the reflective surface is convex.

It is further preferable that, within the range defined by conditional formula (4), the range defined by conditional formula (4a) below be fulfilled.

1.5<H×r(MC1)<2.5 (4a)

For example, the value of r(MC1) can be so small that the value of conditional formula (4) or (4a) is equal to or smaller than the lower limit. If this happens, the negative optical power (making light diverge) of the first curved mirror MC1 in the x-axis direction is comparatively weak. Consequently, the image light is not sufficiently enlarged (is not made sufficiently wide-angled) in the horizontal direction HL on the screen SC, which direction runs in the same direction as the x-axis direction. Thus, the second curved mirror MC2 needs to compensate for the shortage in the negative optical power of the first curved mirror MC1. Increasing the burden on the second curved mirror MC2 for the negative optical power, however, produces curvature of field.

On the other hand, the value of r(MC1) can be so great that the value of conditional formula (4) or (4a) is equal to or greater than the upper limit. If this happens, the negative optical power of the first curved mirror MC1 in the x-axis direction is comparatively strong. Consequently, the image light is sufficiently enlarged in the horizontal direction HL on the screen SC, which direction runs in the same direction as the x-axis direction, and thus the reflective surface of the curved-mirror optical system MCS, which receives the so enlarged image light, needs to be enlarged accordingly. Enlarging the reflective surface of the curved-mirror optical system MCS, however, increases the cost of the second curved mirror MC2, and hence the cost of the projector PD, and also makes the second curved mirror MC2 larger, and hence the projector PD thicker.

Hence, setting the value of H×r(MC1) within the ranges defined by conditional formulae (4) and (4a) allows the projector PD to suppress curvature of field and other aberrations, and simultaneously helps make it slim and inexpensive to manufacture.

In the projector PD of Example 1, the length H of the screen surface in the horizontal direction HL is 1 158 mm, and the curvatures of the reflective surface s19$ of the first curved mirror MC1 are,
in x-axis Direction, 0.00149 mm⁻¹ (i.e. r(MC1)) and,
in y-axis Direction, 0.00009 mm⁻¹.

### Thus, the value of H×r(MC1) is 1.72689, which falls within the ranges defined by both conditional formulae (4) and (4a).

In the projector PD of Example 2, the length H of the screen surface in the horizontal direction HL is 1 158 mm, and the curvatures of the reflective surface s19$ of the first curved mirror MC1 are,
in x-axis Direction, 0.0017345 mm⁻¹ (i.e. r(MC1)) and,
in y-axis Direction, 0.0008220 mm⁻¹.

### Thus, the value of H×r(MC1) is 2.00857, which falls within the ranges defined by both conditional formulae (4) and (4a).

### 1-4-5. Conditional Formula (5)

It is preferable that the projector PD fulfill conditional formula (5) below.

2.5<H×r(MC2)<6.5 (5)

where
H represents the length (in mm) of the screen surface in one direction (horizontal direction HL) in the rectangular coordinate system defined on the screen surface; and
r(MC2) represents the curvature (in mm⁻¹) of the reflective surface of the second curved mirror MC2 at the point on it where the base ray BB reaches it, as measured in the same direction on the reflective surface as the horizontal direction HL (i.e. the x-axis direction of the local coordinate system), the curvature being given a positive sign if the reflective surface is convex.

For example, the value of r(MC2) can be so small that the value of conditional formula (5) is equal to or smaller than the lower limit. If this happens, the negative optical power (making light diverge) of the first curved mirror MC2 in the x-axis direction is comparatively weak. Consequently, the image light is not sufficiently enlarged (is not made sufficiently wide-angled) in the horizontal direction HL on the screen SC, which direction runs in the same direction as the x-axis direction.

To avoid this, the distance between the curved mirrors MC2 and the screen SC needs to be increased, that is, the optical path from the second curved mirror MC2 to the screen SC needs to be extended. Extending this optical path, however, makes the projector PD thicker. The projector is then not satisfactorily slim.

On the other hand, the value of r(MC2) can be so great that the value of conditional formula (5) is equal to or greater than the upper limit. If this happens, the negative optical power of the first curved mirror MC2 in the x-axis direction is comparatively strong. This produces curvature of field, distortion, and other aberrations. The projector then does not offer satisfactorily high performance (resolution).

Hence, setting the value of H×r(MC2) within the range defined by conditional formula (5) allows the projector PD to have a reduced distance between the second curved mirror MC2 and the screen and to suppress curvature of field, distortion, and other aberrations. That is, within that range, the projector PD is slim, and offers high performance.

In the projector PD of Example 1, the length H of the screen surface in the horizontal direction HL is 1 158 mm, and the curvatures of the reflective surface s20$ of the first curved mirror MC2 are,
in x-axis Direction, 0.00480 mm⁻¹ (i.e. r(MC2)) and,
in y-axis Direction, 0.00027 mm⁻¹.

### Thus, the value of H×r(MC2) is 5.5609, which falls within the ranges defined by both conditional formulae (5).

In the projector PD of Example 2, the length H of the screen surface in the horizontal direction HL is 1 158 mm, and the curvatures of the reflective surface s20$ of the first curved mirror MC2 are,
in x-axis Direction, 0.0031182 mm⁻¹ (i.e. r(MC2)) and,
in y-axis Direction, 0.0009210 mm⁻¹.

### Thus, the value of H×r(MC2) is 3.6109, which falls within the ranges defined by both conditional formulae (5).

### 1-4-6. Conditional Formula (6)

It is preferable that the projector PD fulfill conditional formula (6) below.

0.5<D(PS_{IS}−MC1)/V<1.2 (6)

where
V represents the length (in mm) of the screen surface in the other direction (vertical direction VL) in the rectangular coordinate system defined on the screen surface; and
D(PS_{IS}−MC1) represents the length (in mm) of the optical path from the most image-side end of the positively powered optical system PS to the first curved mirror MC1 (more specifically, its reflective surface s19$).

For example, the value of D(PS_{IS}−MC1) can be so small that the value of conditional formula (6) is equal to or smaller than the lower limit. If this happens, the positively powered optical system PS is located inside the space surrounded by the first and second curved mirrors MC1 and MC2. Consequently, the positively powered optical system PS interferes with the optical path up to the screen SC, and thus part of the image light does not reach the screen SC.

On the other hand, the value of D(PS_{IS}−MC1) can be so great that the value of conditional formula (6) is equal to or greater than the upper limit. If this happens, the distance between the first curved mirror MC1 and the positively powered optical system PS is comparatively long. Consequently, if the distance runs substantially in the same direction as the vertical direction VL on the screen SC, the positively powered optical system PS protrudes from behind the back side of the positively powered optical system PS, forming an unduly large chin-like projection.

Hence, setting the value of D(PS_{IS}−MC1)/V within the range defined by conditional formula (6) helps prevent the projector PD from encountering a situation where part of the image light does not reach the screen SC, and also helps prevent an unduly large chin-like projection.

In the projector PD of Example 1, the length V of the screen surface in the vertical direction VL is 645 mm, and the value of D(PS_{IS}−MC1)/V is 0.66000. In the projector PD of Example 2, the length V of the screen surface in the vertical direction VL is equally 645 mm, and the value of D(PS_{IS}−MC1) is 0.95271. Thus, in both examples, the range of conditional formula (6) is fulfilled.

### 2. Other Embodiments

How to put the present invention into practice is not limited to the examples specifically described hereinbefore, and many variations and modifications are possible within the spirit of the invention.

For example, the positively powered optical system PS included in the projection optical system unit PU may be a centered refractive optical system or a decentered refractive optical system. A centered refractive optical system is easier to manufacture and thus contributes more to cost reduction than a decentered refractive optical system.

Not two but three or more curved mirrors MC may be included in the curved-mirror optical system MCS. That is, the curved-mirror optical system MCS may include a plurality of (at least two) curved mirrors MC. It is preferable that the curved mirrors MC have a free-form curved surface as a reflective surface, because then the curved mirrors MC can efficiently correct for curvature of field, distortion, and other aberrations. Any other optical element (such as a lens) may be disposed between adjacent curved mirrors.

Not one but any other number of turning mirror optical systems MHS may be provided. That is, the turning mirror optical system MHS may include a single turning flat mirror MH as described above, or may include a plurality of turning mirrors. What matters here is simply that the turning mirror optical system includes a turning mirror (not limited to a flat mirror) that can guide the image light to the screen SC.

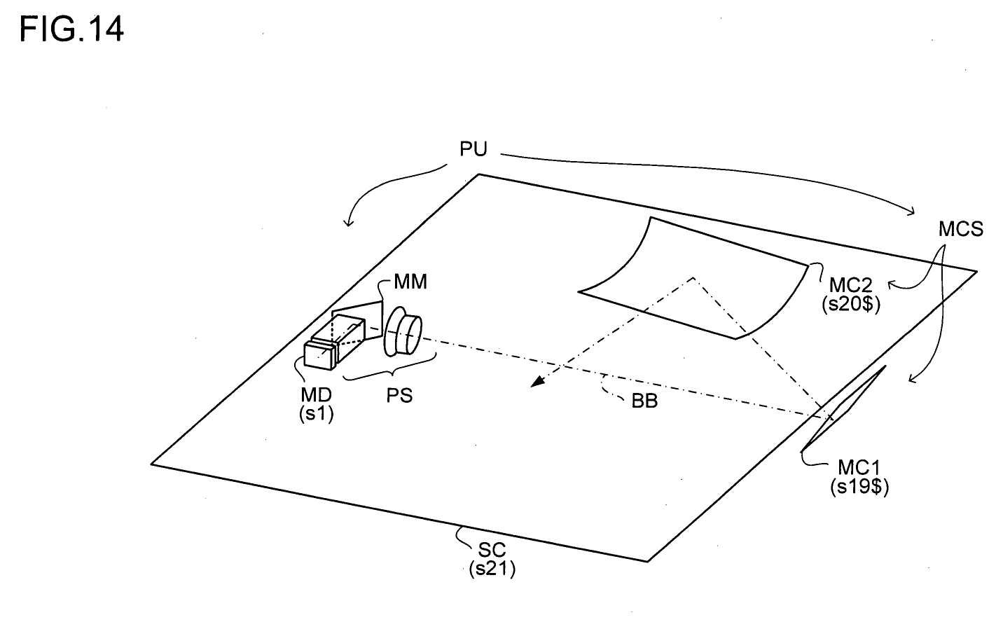

It is preferable that the positively powered optical system PS be located so as to be hidden behind the back side of the screen SC, because doing so makes a chin-like projection less likely to be formed, and helps realize a projector PD that has a large screen but is nevertheless compact. To that end, it is preferable that, as shown in FIG. 14, an optical path changing element (for example, a flat mirror) be disposed in the optical path from the positively powered optical system PS to the curved-mirror optical system MCS (more specifically, the first curved mirror MC1). As shown in FIG. 14, such an optical path changing element MM turns the optical path so that the positively powered optical system PS is located behind the screen surface.

The optical path changing element MM may be disposed elsewhere than in the optical path from the positively powered optical system PS to the curved-mirror optical system MCS; for example, it may be disposed in the optical path through the positively powered optical system PS. What matters here is simply that the optical path changing element MM is disposed in a position where it can change the optical path so that an optical element (such as the positively powered optical system PS) that would otherwise protrude from behind the screen surface is located behind the screen surface.

It should be understood that any projector PD that fulfills one or more of conditional formulae (1) to (6) noted above singly or in an appropriate combination embodies the present invention. The projectors PD described above can alternatively be expressed as follows.

For example, an image projection apparatus is provided with a projection optical system unit that guides image light emitted from a light modulation element so as to project the image light onto a projection surface. This projection optical system unit incorporated in the image projection apparatus includes: a positively powered optical system that has an optical aperture and that has a positive optical power; and a curved-mirror optical system that has at least a first curved mirror and a second curved mirror, the second curved mirror reflecting light reflected from the first curved mirror.

Here, the first and second curved mirrors are so located that, let the ray of the image light that travels from the center of the display surface of the light modulation element through the center of the optical aperture toward the center of the projection surface be called the base ray, the optical path that the base ray travels to reach the first curved mirror crosses the optical path that the base ray travels to leave the second curved mirror. In addition, the second curved mirror has a convex reflective surface.

In this image projection apparatus, the projection optical system unit includes a positively powered optical system that makes the image light converge. With this ability to make light converge, it is possible to make fine the light beam (to reduce its beam width) traveling from the positively powered optical system to the projection surface. Then, if, for example, the direction in which the light beam is made fine coincides with the direction of the depth of the image projection apparatus, the image projection apparatus can be made slim.

In addition, the inclusion of the positively powered optical system makes it possible to correct for aberrations with the different optical powers (positive or negative) of the optical elements constituting it. For example, in a case where the image light is produced by integrating light of different colors together with a color integration prism or the like, the color integration prism produces chromatic aberration; even then, in the above image projection apparatus, the chromatic aberration can be corrected for with those different optical powers.

Moreover, in the image projection apparatus, the projection optical system unit also includes a curved-mirror optical system having a plurality of curved mirrors (a first and a second curved mirror). Thus, in the image projection apparatus, with the curved reflective surfaces, it is possible to correct for curvature of field, distortion, and other aberrations.

In addition, in a case where the image light is reflected first on the first curved mirror and then on the second curved mirror (for example, in a case where the image light is reflected consecutively on the first and second curved mirrors), the first and second curved mirrors are so located that the optical path that the base ray travels to reach the first curved mirror crosses the optical path that the base ray travels to leave the second curved mirror. Thus, the first and second curved mirrors turns the comparatively long optical path. This prevents the image projection apparatus from having an unduly large thickness resulting from a comparatively long optical path.

Furthermore, having a convex reflective surface, the second curved mirror exerts a negative optical power (making light diverge), and this helps achieve sufficient enlargement projection with a comparatively short optical path. That is, the image projection apparatus achieves enlargement projection with a shorter optical path, further suppressing the increase in thickness associated with the optical path.

In summary, in the image projection apparatus described above, the inclusion of the positively powered optical system allows correction for chromatic and other aberrations, and the inclusion of the curved-mirror optical system allows correction for curvature of field, distortion, and other aberrations. In addition, the incorporation of the projection optical system unit designed to be compact thanks to an arrangement in which the optical path reaching the first curved mirror crosses the optical path leaving the second curved mirror prevents the image projection apparatus from having an unduly large thickness. Furthermore, the second curved mirror exerting a negative optical power reduces the optical path length required to obtain a standardized screen size. Thus, it is possible to realize an image projection apparatus that achieves enlargement projection despite being slim.

For further slimness, higher performance (further suppressed aberrations), and other advantages, it is preferable that the image projection apparatus fulfill one or more conditional formulae. For example, it is preferable that the image projection apparatus fulfill conditional formula (1) below.

15<θ1<45 (1)

where
θ1 represents the angle of incidence (in degrees) at which the base ray reaches the first curved mirror.

If the value of conditional formula (1) is equal to or smaller than the lower limit, for example, the image light traveling from the positively powered optical system to the first curved mirror is intercepted by the second curved mirror. Moreover, the reflective surface of the first curved mirror may be located opposite the positively powered optical system (refractive optical system), in which case, if the distance across which they face each other runs in the same direction as the thickness of the image projection apparatus, the image projection apparatus is unduly thick.

On the other hand, if the value of conditional formula (1) is equal to or greater than the upper limit, for example, the second curved mirror and the positively powered optical system are located far away from each other. Consequently, if the direction in which they are located away from each other runs in the same direction as the thickness of the image projection apparatus, the image projection apparatus is unduly thick. Moreover, the image light reaches the first curved mirror at a comparatively large angle of incidence, and this produces trapezoid distortion.

These inconveniences are avoided within the range defined by conditional formula (1). The image projection apparatus then operates with suppressed aberrations despite being slim.

It is further preferable that the image projection apparatus fulfill conditional formula (1a) below.

20<θ1<35 (1a)

It is preferable that the image projection apparatus fulfill conditional formula (2) below.

30<θ2<60 (2)

where
θ2 represents the angle of incidence (in degrees) at which the base ray reaches the second curved mirror.

If the value of conditional formula (2) is equal to or smaller than the lower limit, for example, the reflective surface of first curved mirror moves so as to face the reflective surface of the second curved mirror. When this happens, if another member (for example, the projection surface) is disposed that receives the image light from the second curved mirror, the first curved mirror collide with that member.

On the other hand, if the value of conditional formula (2) is equal to or greater than the upper limit, for example, as the second curved mirror moves, the angle between the reflective surfaces of the first and second curved mirrors increases. When this happens, the second curved mirror moves away from the positively powered optical system, and hence away from the edge of the projection surface. Consequently, an unduly large part of the second curved mirror (also called a chin-like projection) protrudes from the edge of the projection surface. Moreover, the image light reaches the second curved mirror at a comparatively large angle of incidence, and this produces trapezoid distortion.

These inconveniences are avoided within the range defined by conditional formula (2). The image projection apparatus then has the first curved mirror and other components arranged properly, and in addition offers compactness combined with high performance (operating with excellently suppressed aberrations).

It is further preferable that the image projection apparatus fulfill conditional formula (2a) below.

35<θ2<55 (2a)

The image projection apparatus may simultaneously fulfill conditional formulae (1) and (2), or conditional formulae (1a) and (2), or conditional formulae (1) and (2a), or conditional formulae (1a) and (2a).

The image projection apparatus may have the projection surface arranged substantially parallel to the optical path along which the base ray travels from the positively powered optical system to the first curved mirror. It is particularly preferable that the so constructed image projection apparatus fulfill conditional formulae (1) and (2).

It is preferable that the image projection apparatus fulfill conditional formula (3) below.

25<θ3<50 (3)

where
θ3 represents the angle (in degrees) between the direction in which the base ray travels to reach the first curved mirror and the direction in which the base ray travels to leave the second curved mirror.

If the value of conditional formula (3) is equal to or smaller than the lower limit, for example, the positively powered optical system that feeds the image light to the first curved mirror is located away from the second curved mirror, and the optical path of the image light leaving the second curved mirror slides toward the positively powered optical system. When this happens, the positively powered optical system interferes with the optical path. Moreover, if another member (for example, a turning flat mirror) is disposed in the direction in which the image light from the second curved mirror travels, the image light from the positively powered optical system is intercepted by that member.

On the other hand, if the value of conditional formula (3) is equal to or greater than the upper limit, for example, the positively powered optical system is located close to the second curved mirror. When this happens, if the projection surface is located in the direction opposite from the direction in which the positively powered optical system is located close, the image projection apparatus has an unduly large thickness; if the projection surface is located farther in the direction in which the positively powered optical system is located close, the positively powered optical system protrudes from the edge of the projection surface, forming an unduly large chin-like projection.

These inconveniences are avoided within the range defined by conditional formula (3). The image projection apparatus is then slim (or compact) while simultaneously being free from interception of the image light.

It is particularly preferable that the image projection apparatus fulfill conditional formulae (1) and (2) in addition to conditional formula (3).

The image projection apparatus achieves enlargement projection of image light by exploiting the optical powers of curved mirrors. Thus, appropriately setting the optical powers of curved mirrors leads to higher performance and further slimness. Accordingly, for example, it is preferable that the image projection apparatus fulfill one or more of the following conditional formulae. Specifically, it is preferable that the image projection apparatus fulfill conditional formula (4) below.

1.0<H×r(MC1)<3.0 (4)

where
H represents the length (in mm) of the screen surface in one direction (horizontal direction) in the rectangular coordinate system defined on the screen surface; and
r(MC1) represents the curvature (in mm⁻¹) of the reflective surface of the first curved mirror at the point on it where the base ray reaches it, as measured in the same direction on the reflective surface as the horizontal direction, the curvature being given a positive sign if the reflective surface is convex.

For example, if the value of conditional formula (4) is equal to or smaller than the lower limit, the negative optical power of the first curved mirror in the same direction as the horizontal direction of the projection surface is comparatively weak, and thus the image light is not sufficiently enlarged (is not made sufficiently wide-angled). If this happens, the shortage in the negative optical power of the first curved mirror may be compensated for by the second curved mirror. This, however, increases the burden on the second curved mirror for the negative optical power, consequently producing curvature of field.

On the other hand, if the value of conditional formula (4) is equal to or greater than the upper limit, the above-mentioned negative optical power of the first curved mirror is comparatively strong, and accordingly the image light traveling from the first curved mirror to the second curved mirror has an increased beam width. To receive the image light having the thus increased beam width, the reflective surface of the second curved mirror needs to be enlarged at extra cost.

These inconveniences are avoided within the range defined by conditional formula (4). The image projection apparatus is then slim despite offering high performance, and is inexpensive to manufacture.

It is particularly preferable that the image projection apparatus fulfill conditional formulae (1) and (2) in addition to conditional formula (4).

It is preferable that the image projection apparatus fulfill conditional formula (5) below.

2.5<H×r(MC2)<6.5 (5)

where
H represents the length (in mm) of the screen surface in one direction (horizontal direction) in the rectangular coordinate system defined on the screen surface; and
r(MC2) represents the curvature (in mm⁻¹) of the reflective surface of the second curved mirror at the point on it where the base ray reaches it, as measured in the same direction on the reflective surface as the horizontal direction, the curvature being given a positive sign if the reflective surface is convex.

For example, if the value of conditional formula (5) is equal to or smaller than the lower limit, the negative optical power of the second curved mirror in the same direction as the horizontal direction of the projection surface is comparatively weak, and thus the image light is not sufficiently enlarged (is not made sufficiently wide-angled). If this happens, the distance between the reflective surface of the second curved mirror and the projection surface needs to be increased, that is, the optical path needs to be extended. This, however, makes the image projection apparatus unduly thick.

On the other hand, if the value of conditional formula (5) is equal to or greater than the upper limit, the negative optical power of the second curved mirror in the same direction as the horizontal direction of the projection surface is comparatively strong. This produces curvature of field, distortion, and other aberrations.

These inconveniences are avoided within the range defined by conditional formula (5). The image projection apparatus then offers high performance despite being slim.

It is particularly preferable that the image projection apparatus fulfill conditional formulae (1) and (2) in addition to conditional formula (5).

It is preferable that the image projection apparatus fulfill conditional formula (6) below.

0.5<D(PS_{IS}−MC1)/V<1.2 (6)

where
V represents the length (in mm) of the screen surface in the other direction (vertical direction) in the rectangular coordinate system defined on the screen surface; and
D(PS_{IS}−MC1) represents the length (in mm) of the optical path from the most image-side end of the positively powered optical system to the first curved mirror.

For example, if the value of conditional formula (6) is equal to or smaller than the lower limit, for example, the reflective surface of the first curved mirror is too close to the positively powered optical system. Consequently, the positively powered optical system interferes with the optical path running in the refection-surface side of the first curved mirror, and thus part of the image light does not reach the projection surface.

On the other hand, if the value of conditional formula (6) is equal to or greater than the upper limit, for example, the reflective surface of the first curved mirror is comparatively far away from the positively powered optical system. Consequently, the positively powered optical system protrudes from behind the back side of the projection surface (forming an unduly large chin-like projection).

These inconveniences are avoided within the range defined by conditional formula (6). The image projection apparatus is then compact while simultaneously being free from interception of the image light.

It is particularly preferable that the image projection apparatus fulfill conditional formulae (1) and (2) in addition to conditional formula (6).

It is especially preferable that the image projection apparatus fulfill conditional formula (3) in addition to conditional formulae (6), (1), and (2).

As described above, according to the present invention, an image projection apparatus includes a projection optical system unit and a light modulation element emitting image light, and may further include, in the optical path through a positively powered optical system or in the optical path from the positively powered optical system to a curved mirror optical system, an optical path changing element changing the optical path of the image light.

It should be understood that any embodiments, examples, and the like specifically described herein are merely intended to clarify the technical features of the invention and thus are not intended to limit in any way the interpretation of the invention; that is, the invention may be put into practice with any modifications and variations made within the scope of the appended claims.

TABLE 1
Example 1

| | | |
|---|---|---|
| MD | s1 | r1 |
| | | ∞ |

TABLE 2
Example1

| | |
|---|---|
| d1 | 20.300000 |

| | | | | |
|---|---|---|---|---|
| PB | N1 | ν1 | s2 | r2 |
| | 1.51680 | 65.261 | | ∞ |

| | |
|---|---|
| d2 | 38.220000 |

| | |
|---|---|
| s3 | r3 |
| | ∞ |

TABLE 3
Example1

| L1 | N2 | ν2 | s4* | r4 |
|---|---|---|---|---|
| | 1.79850 | 22.600 | | 34.90685 |

| Decentering Displacements | | | | | |
|---|---|---|---|---|---|
| XDE | 0.000000 | YDE | 5.000000 | ZDE | 64.520000 |
| ADE | 0.000000 | BDE | 0.000000 | CDE | 0.000000 |

| Aspherical Surface Coefficients | |
|---|---|
| K | 0.00000 |

| | | | |
|---|---|---|---|
| A | −0.347807 E−05 | B | −0.150830 E−08 |
| C | −0.140791 E−11 | D | −0.241289 E−14 |

| | |
|---|---|
| d4 | 10.952541 |

| | |
|---|---|
| s5* | r5 |
| | −184.749659 |

| Aspherical Surface Coefficients | |
|---|---|
| K | 0.000000 |

| | | | |
|---|---|---|---|
| A | 0.111854 E−05 | B | −0.185182 E−08 |
| C | −0.447796 E−12 | D | −0.298784 E−16 |

TABLE 4
Example 1

| | |
|---|---|
| d5 | 14.886804 |

| | | | | | |
|---|---|---|---|---|---|
| JL | L2 | N3 | υ3 | s6 | r6 |
| | | 1.84544 | 23.789 | | 230.14134 |

| | |
|---|---|
| d6 | 1.000000 |

| | | | | |
|---|---|---|---|---|
| | | | s7 | r7 |
| L3 | N4 | υ4 | | 15.76896 |

| | | | |
|---|---|---|---|
| 1.52983 | 65.064 | d7 | 11.702694 |

| | | | | |
|---|---|---|---|---|
| | | | s8 | r8 |
| L4 | N5 | υ5 | | −23.26426 |

| | | | |
|---|---|---|---|
| 1.78851 | 22.909 | d8 | 1.000000 |

| | |
|---|---|
| s9 | r9 |
| | 41.64609 |

TABLE 5
Example 1

| | |
|---|---|
| d9 | 0.500000 |

| | | | | |
|---|---|---|---|---|
| L5 | N6 | υ6 | s10* | r10 |
| | 1.49548 | 69.284 | | 47.64546 |
| | | | | Aspherical Surface Coefficients |

| | |
|---|---|
| K | 0.000000 |

| | | | |
|---|---|---|---|
| A | −0.831923 E−06 | B | 0.146944 E−07 |
| C | −0.606332 E−10 | D | 0.286308 E−12 |

| | |
|---|---|
| d10 | 4.928913 |

| | |
|---|---|
| s11* | r11 |
| | −120.93190 |
| | Aspherical Surface Coefficients |

| | |
|---|---|
| K | 0.000000 |

| | | | |
|---|---|---|---|
| A | −0.877734 E−05 | B | −0.571492 E−08 |
| C | −0.597906 E−10 | D | 0.420948 E−13 |

TABLE 6
Example 1

| | |
|---|---|
| d11 | 19.846409 |

| | | | | |
|---|---|---|---|---|
| L6 | N7 | υ7 | s12 | r12 |
| | 1.79850 | 22.600 | | −197.77798 |

| | |
|---|---|
| d12 | 4.340014 |

| | |
|---|---|
| s13 | r13 |
| | −44.34243 |

TABLE 7
Example 1

| | |
|---|---|
| d13 | 0.100000 |

| | | |
|---|---|---|
| ST | s14 | r14 |
| | | ∞ |

TABLE 8
Example 1

| | |
|---|---|
| d14 | 196.530382 |

| | | | | |
|---|---|---|---|---|
| L7 | N8 | υ8 | s15 | r15 |
| | 1.60212 | 58.855 | | 90.95790 |

| | |
|---|---|
| d15 | 14.835077 |

| | |
|---|---|
| s16 | r16 |
| | −363.43662 |

TABLE 9
Example 1

| | |
|---|---|
| d16 | 53.857166 |

| | | | | |
|---|---|---|---|---|
| L8 | N9 | υ9 | s17* | r17 |
| | 1.54281 | 50.637 | | −43.42075 |
| | | | | Aspherical Surface Coefficients |

| | |
|---|---|
| K | 0.000000 |

| | | | |
|---|---|---|---|
| A | −0.113499 E−05 | B | 0.143364 E−08 |
| C | 0.544718 E−12 | D | −0.535301 E−16 |

| | |
|---|---|
| d17 | 1.000000 |

| | |
|---|---|
| s18* | r18 |
| | 111.28639 |
| | Aspherical Surface Coefficients |

| | |
|---|---|
| K | 0.000000 |

| | | | |
|---|---|---|---|
| A | −0.261256 E−05 | B | 0.729366 E−09 |
| C | 0.215419 E−12 | D | −0.964728 E−16 |

TABLE 10
Example 1

| | | |
|---|---|---|
| MC1 | s19$ | r19 |
| | | ∞ |
| | | Decentering Displacements |

| XDE | 0.000000 | YDE | 5.000000 | ZDE | 870.000000 |
|---|---|---|---|---|---|
| ADE | 35.000000 | BDE | 0.000000 | CDE | 0.000000 |
| Free-form Surface Coefficients | | | | | |
| C(0,1) | −2.7523 E−02 | C(2,0) | 3.0657 E−03 | (0,2) | −3.7607 E−03 |
| C(2,1) | −4.5687 E−05 | C(0,3) | 2.1575 E−04 | C(4,0) | −6.1693 E−07 |
| C(2,2) | 2.8494 E−07 | C(0.4) | −4.4602 E−06 | C(4,1) | 9.2687 E−09 |
| C(2,3) | −3.5957 E−09 | C(0,5) | 4.8019 E−08 | C(6,0) | 6.8900 E−11 |
| C(4,2) | −2.1239 E−11 | C(2,4) | 7.2910 E−11 | C(0,6) | −2.7972 E−10 |
| C(6,1) | −8.6130 E−13 | C(4,3) | −3.8636 E−13 | C(2,5) | −6.2234 E−13 |
| C(0,7) | 7.9011 E−13 | C(8,0) | −3.4236 E−15 | C(6,2) | 3.8699 E−15 |
| C(4,4) | 9.3649 E−16 | C(2,6) | 1.5649 E−15 | C(0,8) | −7.1135 E−16 |
| C(8,1) | 2.3386 E−17 | C(6,3) | 3.3379 E−18 | C(4,5) | 1.6706 E−17 |
| C(2,7) | 4.0538 E−18 | C(0,9) | 7.6093 E−19 | C(10,0) | 6.3279 E−20 |
| C(8,2) | −8.2630 E−20 | C(6,4) | −4.1214 E−20 | C(4,6) | −7.0310 E−20 |
| C(2,8) | −1.7063 E−20 | C(0,10) | −5.8863 E−21 | | |

TABLE 11
Example 1

| | | |
|---|---|---|
| MC2 | s20$ | r20 |
| | | ∞ |
| | | Decentering Displacements |

| XDE | 0.000000 | YDE | 14.396926 | ZDE | 873.420201 |
|---|---|---|---|---|---|
| ADE | 74.216735 | BDE | 0.000000 | CDE | 0.000000 |
| Free-form Surface Coefficients | | | | | |
| C(0,1) | −4.3076 E−01 | C(2,0) | −5.1764 E−03 | C(0,2) | 1.5997 E−04 |
| C(2,1) | 2.0641 E−05 | C(0,3) | −3.1508 E−05 | C(4,0) | 1.6737 E−07 |
| C(2,2) | 2.8491 E−07 | C(0,4) | 2.8224 E−07 | C(4,1) | −1.9930 E−09 |
| C(2,3) | −2.9091 E−09 | C(0,5) | −6.3274 E−10 | C(6,0) | −8.6522 E−13 |
| C(4,2) | −1.6282 E−12 | C(2,4) | 7.9519 E−12 | C(0,6) | −1.8951 E−12 |
| C(6,1) | 7.1567 E−14 | C(4,3) | 4.5051 E−14 | C(2,5) | 1.3145 E−14 |
| C(0,7) | 2.6879 E−15 | C(8,0) | −1.3897 E−16 | C(6,2) | −1.2610 E−16 |
| C(4,4) | −6.8190 E−17 | C(2,6) | −7.2277 E−17 | C(0,8) | 3.1534 E−17 |
| C(8,1) | −8.6525 E−19 | C(6,3) | −2.0793 E−19 | C(4,5) | −2.1924 E−19 |
| C(2,7) | −1.7262 E−19 | C(0,9) | 1.0628 E−20 | C(10,0) | 2.7144 E−21 |
| C(8,2) | 1.8816 E−21 | C(6,4) | 3.6013 E−22 | C(4,6) | 4.4599 E−22 |
| C(2,8) | 8.0317 E−22 | C(0,10) | −2.8183 E−22 | | |

TABLE 12
Example 1

| | | |
|---|---|---|
| SC | s21 | r21 |
| | | ∞ |
| | | Decentering Displacements |

| | | | | | |
|---|---|---|---|---|---|
| XDE | 0.000000 | YDE | 123.488473 | ZDE | 895.747077 |
| ADE | 86.620590 | BDE | 0.000000 | CDE | 0.000000 |

TABLE 13
Example 2

| | | |
|---|---|---|
| MD | s1 | r1 |
| | | ∞ |

TABLE 14
Example 2

| | |
|---|---|
| d1 | 20.300000 |

| | | | | |
|---|---|---|---|---|
| PB | N1 | υ1 | s2 | r2 |
| | 1.51680 | 65.261 | | ∞ |

| | |
|---|---|
| d2 | 38.220000 |

| | |
|---|---|
| s3 | r3 |
| | ∞ |

TABLE 15
Example 2

| | | | | |
|---|---|---|---|---|
| L1 | N2 | υ2 | s4* | r4 |
| | 1.79850 | 22.600 | | 78.26315 |
| | | | | Decentering Displacements |

| | | | | | |
|---|---|---|---|---|---|
| XDE | 0.000000 | YDE | 4.500000 | ZDE | 64.520000 |
| ADE | 0.000000 | BDE | 0.000000 | CDE | 0.000000 |

| Aspherical Surface Coefficients | |
|---|---|
| K | 0.000000 |

| | | | |
|---|---|---|---|
| A | −0.222479 E−05 | B | 0.174620 E−08 |
| C | −0.178795 E−12 | D | −0.141731 E−14 |

| | |
|---|---|
| d4 | 11.660324 |

| | |
|---|---|
| s5* | r5 |

| −108.23143 | |
|---|---|
| Aspherical Surface Coefficients | |
| K | 0.000000 |

| | | | |
|---|---|---|---|
| A | −0.107148 E−05 | B | 0.142658 E−08 |
| C | −0.226435 E−12 | D | −0.113904 E−14 |

TABLE 16
Example 2

| | |
|---|---|
| d5 | 31.112958 |

| | | | | | |
|---|---|---|---|---|---|
| JL | L2 | N3 | υ3 | s6 | r6 |
| | | 1.84330 | 25.093 | | 144.18515 |

| | |
|---|---|
| d6 | 1.000000 |

| | | | | |
|---|---|---|---|---|
| | | | s7 | r7 |
| L3 | N4 | υ4 | | 17.30899 |

| | | | |
|---|---|---|---|
| 1.75450 | 51.570 | d7 | 14.307804 |

| | | | | |
|---|---|---|---|---|
| | | | s8 | r8 |
| L4 | N5 | υ5 | | −20.67779 |

| | | | |
|---|---|---|---|
| 1.66225 | 28.938 | d8 | 1.000000 |

| | |
|---|---|
| s9 | r9 |
| | 51.14463 |

TABLE 17
Example 2

| | |
|---|---|
| d9 | 6.000000 |

| | | | | |
|---|---|---|---|---|
| L5 | N6 | υ6 | s10* | r10 |
| | 1.75316 | 30.828 | | −40.83798 |
| | | | | Aspherical Surface Coefficients |

| | |
|---|---|
| K | 0.000000 |

| | | | |
|---|---|---|---|
| A | −0.417480 E−04 | B | 0.150801 E−07 |
| C | −0.528015 E−10 | D | −0.344130 E−12 |

| | |
|---|---|
| d10 | 6.010725 |

| | |
|---|---|
| s11* | r11 |
| | −163.79479 |
| | Aspherical Surface Coefficients |

| | |
|---|---|
| K | 0.000000 |

| | | | |
|---|---|---|---|
| A | −0.283908 E−04 | B | 0.484149 E−07 |
| C | −0.894327 E−10 | D | 0.691827 E−13 |

TABLE 18
Example 2

| | |
|---|---|
| d11 | 6.120142 |

| | | | | |
|---|---|---|---|---|
| L6 | N7 | υ7 | s12 | r12 |
| | 1.79850 | 22.600 | | −100.63142 |

| | |
|---|---|
| d12 | 4.955513 |

| | |
|---|---|
| s13 | r13 |
| | −33.79907 |

TABLE 19
Example 2

| | |
|---|---|
| d13 | 0.100000 |

| | | |
|---|---|---|
| ST | s14 | r14 |
| | | ∞ |

TABLE 20
Example 2

| | |
|---|---|
| d14 | 115.919963 |

| | | | | |
|---|---|---|---|---|
| L7 | N8 | υ8 | s15 | r15 |
| | 1.85000 | 40.040 | | 72.66211 |

| | |
|---|---|
| d15 | 11.204748 |

| | |
|---|---|
| s16 | r16 |
| | −237.45446 |

TABLE 21
Example 2

| | |
|---|---|
| d16 | 15.087824 |

| | | | | |
|---|---|---|---|---|
| L8 | N9 | υ9 | s17* | r17 |
| | 1.58366 | 37.162 | | −61.16649 |
| | | | | Aspherical Surface Coefficients |

| | |
|---|---|
| K | 0.000000 |

| | | | |
|---|---|---|---|
| A | 0.142550 E−06 | B | 0.773130 E−09 |
| C | −0.168483 E−12 | D | 0.154634 E−16 |

| | |
|---|---|
| d17 | 1.000000 |

| | |
|---|---|
| s18* | r18 |
| | 60.60827 |
| | Aspherical Surface Coefficients |

| | |
|---|---|
| K | 0.000000 |

| | | | |
|---|---|---|---|
| A | −0.456565 E−06 | B | 0.158374 E−09 |
| C | −0.922060 E−13 | D | 0.548803 E−16 |

TABLE 22
Example 2

| | | |
|---|---|---|
| MC1 | s19$ | r19 |
| | | ∞ |
| | | Decentering Displacements |

| XDE | 0.000000 | YDE | 4.500000 | ZDE | 938.626822 |
|---|---|---|---|---|---|
| ADE | 47.000000 | BDE | 0.000000 | CDE | 0.000000 |
| Free-form Surface Coefficients | | | | | |
| C(0,1) | 1.3433 E−01 | C(2,0) | 1.2676 E−03 | C(0,2) | 5.2970 E−04 |
| C(2,1) | −4.0300 E−06 | C(0,3) | 3.2367 E−05 | C(4,0) | −2.0751 E−07 |
| C(2,2) | −2.7750 E−08 | C(0,4) | −9.3364 E−07 | C(4,1) | 1.9362 E−09 |
| C(2,3) | −2.7312 E−09 | C(0,5) | 1.3583 E−08 | C(6,0) | 3.2347 E−11 |
| C(4,2) | 1.6471 E−11 | C(2,4) | 7.0277 E−11 | C(0,6) | −1.2131 E−10 |
| C(6,1) | −2.5481 E−13 | C(4,3) | −3.7469 E−13 | C(2,5) | −5.8999 E−13 |
| C(0,7) | 6.4805 E−13 | C(8,0) | −2.9824 E−15 | C(6,2) | −1.1245 E−15 |
| C(4,4) | 1.2056 E−15 | C(2,6) | 1.0746 E−15 | C(0,8) | −1.4335 E−15 |
| C(8,1) | 1.5211 E−17 | C(6,3) | 3.1057 E−17 | C(4,5) | 6.6273 E−18 |
| C(2,7) | 8.2311 E−18 | C(0,9) | −3.8670 E−18 | C(10,0) | 1.1557 E−19 |
| C(8,2) | −6.1870 E−20 | C(6,4) | −1.2470 E−19 | C(4,6) | −2.4702 E−20 |
| C(2,8) | −2.9078 E−20 | C(0,10) | 2.1915 E−20 | | |

TABLE 23
Example 2

| | | |
|---|---|---|
| MC2 | s20$ | r20 |
| | | ∞ |
| | | Decentering Displacements |

| XDE | 0.000000 | YDE | −45.378203 | ZDE | 942.114646 |
|---|---|---|---|---|---|
| ADE | 94.000000 | BDE | 0.000000 | CDE | 0.000000 |
| Free-form Surface Coefficients | | | | | |
| C(0,1) | −4.2231 E−03 | C(2,0) | −2.3584 E−03 | C(0,2) | −1.9692 E−03 |
| C(2,1) | 3.1462 E−06 | C(0,3) | 1.8844 E−05 | C(4,0) | −3.4982 E−08 |
| C(2,2) | 1.6720 E−07 | C(0,4) | −1.7636 E−07 | C(4,1) | 8.2156 E−10 |
| C(2,3) | −2.2100 E−09 | C(0.5) | 1.0062 E−09 | C(6,0) | 6.8362 E−12 |
| C(4,2) | −1.5917 E−11 | C(2,4) | 1.4517 E−11 | C(0,6) | −2.1822 E−12 |
| C(6,1) | −8.5398 E−15 | C(4,3) | 7.5063 E−14 | C(2,5) | −3.8974 E−14 |
| C(0,7) | −3.9971 E−15 | C(8,0) | −4.8160 E−16 | C(6,2) | 5.7948 E−16 |
| C(4,4) | −2.2029 E−17 | C(2,6) | 9.8623 E−18 | C(0,8) | 9.0748 E−20 |
| C(8,1) | −1.7833 E−18 | C(6,3) | −3.1787 E−18 | C(4,5) | −9.9215 E−19 |
| C(2,7) | −1.4078 E−19 | C(0,9) | 2.1327 E−19 | C(10,0) | 1.6702 E−20 |
| C(8,2) | 2.7937 E−22 | C(6,4) | 7.5076 E−21 | C(4,6) | 2.4696 E−21 |
| C(2,8) | 9.0382 E−22 | C(0,10) | −6.1669 E−22 | | |

TABLE 24
Example 2

| | | |
|---|---|---|
| MH | s21 | r21 |
| | | ∞ |
| | | Decentering Displacements |

| | | | | | |
|---|---|---|---|---|---|
| XDE | 0.000000 | YDE | 104.256405 | ZDE | 931.651175 |
| ADE | 94.000000 | BDE | 0.000000 | CDE | 0.000000 |

TABLE 25
Example 2

| | | |
|---|---|---|
| SC | s22 | r22 |
| | | ∞ |
| | | Decentering Displacements |

| | | | | | |
|---|---|---|---|---|---|
| XDE | 0.000000 | YDE | −95.256405 | ZDE | 945.602470 |
| ADE | 94.000000 | BDE | 0.000000 | CDE | 0.000000 |

TABLE 26

| | | Example 1 | Example 2 |
|---|---|---|---|
| Conditional Formula(1) | θ1 | 34.1 | 34.5 |
| Conditional Formula(2) | θ2 | 39.0 | 40.1 |
| Conditional Formula(3) | θ3 | 9.8 | 11.1 |
| Conditional Formula(4) | H × r(MC1) | −2.33928 | −2.26484 |
| Conditional Formula(5) | H × r(MC2) | 7.94061 | 9.32355 |

1. An image projection apparatus comprising:
a projection optical system unit that guides image light emitted from a light modulation element so as to project the image light onto a projection surface,
wherein the projection optical system unit includes:
a positively powered optical system that has an optical aperture and that has a positive optical power; and
a curved-mirror optical system that has at least a first curved mirror and a second curved mirror, the second curved mirror reflecting light reflected from the first curved mirror,
wherein the first and second curved mirrors are so located that,
let a ray of the image light that travels from a center of a display surface of the light modulation element through a center of the optical aperture toward a center of the projection surface be called a base ray,
an optical path that the base ray travels to reach the first curved mirror crosses an optical path that the base ray travels to leave the second curved mirror, and
wherein the second curved mirror has a convex reflective surface.

2. The image projection apparatus of claim 1,
wherein conditional formula (1) below is fulfilled:
15<θ1<45 (1)
where
θ1 represents an angle of incidence (in degrees) at which the base ray reaches the first curved mirror.

3. The image projection apparatus of claim 2,
wherein conditional formula (1a) below is fulfilled:
20<θ1<35 (1a)

4. The image projection apparatus of claim 1,
wherein conditional formula (2) below is fulfilled:
30<θ2<60 (2)
where
θ2 represents an angle of incidence (in degrees) at which the base ray reaches the second curved mirror.

5. The image projection apparatus of claim 4,
wherein conditional formula (2a) below is fulfilled:
35<θ2<55 (2a)

6. The image projection apparatus of claim 4,
wherein conditional formula (1) below is fulfilled:
15<θ1<45 (1)
where
θ1 represents an angle of incidence (in degrees) at which the base ray reaches the first curved mirror.

7. The image projection apparatus of claim 1,
wherein the projection surface is arranged substantially parallel to the optical path that the base ray travels from the positively powered optical system to the first curved mirror.

8. The image projection apparatus of claim 7,
wherein conditional formulae (1) and (2) below are fulfilled:
15<θ1<45 (1)
30<θ2<60 (2)
where
θ1 represents an angle of incidence (in degrees) at which the base ray reaches the first curved mirror; and
θ2 represents an angle of incidence (in degrees) at which the base ray reaches the second curved mirror.

9. The image projection apparatus of claim 1,
wherein conditional formula (3) below is fulfilled:
25<θ3<50 (3)
where
θ3 represents an angle between a direction in which the base ray travels to reach the first curved mirror and a direction in which the base ray travels to leave the second curved mirror.

10. The image projection apparatus of claim 9,
wherein conditional formulae (1) and (2) below are fulfilled:
15<θ1<45 (1)
30<θ2<60 (2)
where
θ1 represents an angle of incidence (in degrees) at which the base ray reaches the first curved mirror; and
θ2 represents an angle of incidence (in degrees) at which the base ray reaches the second curved mirror.

11. The image projection apparatus of claim 1,
wherein conditional formula (4) below is fulfilled:
1.0<H×r(MC1)<3.0 (4)
where
H represents a length (in mm) of the screen surface in a horizontal direction in a rectangular coordinate system defined on the screen surface; and
r(MC1) represents a curvature (in mm⁻¹) of a reflective surface of the first curved mirror at a point thereon where the base ray reaches the first curved mirror, as measured in a same direction on the reflective surface as the horizontal direction, the curvature being given a positive sign if the reflective surface is convex.

12. The image projection apparatus of claim 11,
wherein conditional formulae (1) and (2) below are fulfilled:
15<θ1<45 (1)
30<θ2<60 (2)
where
θ1 represents an angle of incidence (in degrees) at which the base ray reaches the first curved mirror; and
θ2 represents an angle of incidence (in degrees) at which the base ray reaches the second curved mirror.

13. The image projection apparatus of claim 1,
wherein conditional formula (5) below is fulfilled:
2.5<H×r(MC2)<6.5 (5)
where
H represents a length (in mm) of the screen surface in a horizontal direction in a rectangular coordinate system defined on the screen surface; and
r(MC2) represents a curvature (in mm⁻¹) of the reflective surface of the second curved mirror at a point thereon where the base ray reaches the second curved mirror, as measured in a same direction on the reflective surface as the horizontal direction, the curvature being given a positive sign if the reflective surface is convex.

14. The image projection apparatus of claim 13,
wherein conditional formulae (1) and (2) below are fulfilled:
15<θ1<45 (1)
30<θ2<60 (2)
where
θ1 represents an angle of incidence (in degrees) at which the base ray reaches the first curved mirror; and
θ2 represents an angle of incidence (in degrees) at which the base ray reaches the second curved mirror.

15. The image projection apparatus of claim 1,
wherein conditional formula (6) below is fulfilled:
0.5<D(PS_{IS}−MC1)/V<1.2 (6)
where
V represents a length (in mm) of the screen surface in a vertical direction in a rectangular coordinate system defined on the screen surface; and
D(PS_{IS}−MC1) represents a length (in mm) of an optical path from a most image-side end of the positively powered optical system to the first curved mirror.

16. The image projection apparatus of claim 15,
wherein conditional formulae (1) and (2) below are fulfilled:
15<θ1<45 (1)
30<θ2<60 (2)
where
θ1 represents an angle of incidence (in degrees) at which the base ray reaches the first curved mirror; and
θ2 represents an angle of incidence (in degrees) at which the base ray reaches the second curved mirror.

17. The image projection apparatus of claim 15,
wherein conditional formula (3) below is fulfilled:
25<θ3<50 (3)
where
θ3 represents an angle between a direction in which the base ray travels to reach the first curved mirror and a direction in which the base ray travels to leave the second curved mirror.

18. The image projection apparatus of claim 17, further comprising:
the light modulation element that emits the image light.

19. The image projection apparatus of claim 1,
wherein an optical path changing element for changing an optical path of the image light is disposed in an optical path within the positively powered optical system or in an optical path from the positively powered optical system to the curved-mirror optical system.

20. The image projection apparatus of claim 1, further comprising:
the light modulation element that emits the image light.
